(19) United States
(12) Patent Application Publication
(10) Pub. No.: US 2023/0036888 A1
(43) Pub. Date: Feb. 2, 2023

(54) ELECTRONIC GOLFING AID SYSTEMS AND METHODS THEREOF

(71) Applicant: Maxualize LLC, Rochester, NY (US)

(72) Inventors: Dante Robert PENNACCHIA, Rochester, NY (US); James F. MUNRO, Ontario, NY (US)

(21) Appl. No.: 17/859,876

(22) Filed: Jul. 7, 2022

Related U.S. Application Data
(63) Continuation-in-part of application No. 16/728,967, filed on Dec. 27, 2019, now abandoned.

(51) Int. Cl. A63B 69/36; A63B 71/06; A63B 24/00

(52) U.S. Cl. CPC A63B 69/3658; A63B 71/0622; A63B 24/0021; A63B 2220/05; A63B 2220/34; A63B 2220/807; A63B 2220/76; A63B 2071/0647; A63B 2071/0655; A63B 2071/0625; A63B 2214/00; A63B 2024/0031; A63B 2024/0034

(57) ABSTRACT

A golfing aid system and method includes an image capturing device and an interface system coupled to at least one processor and a memory coupled to the processor which is configured to be capable of executing programmed instructions comprising and stored in the memory to capture, with the image capture device, image data comprising at least one of a playing surface, a ball, or a designated location spaced from the ball on the playing surface. At least one type of spatial data and at least one type of playing surface data relating to the playing surface, the ball and the designated location is determined. An overall trajectory, a starting direction, and an initial velocity of the ball to reach the designated location is computed, wherein the computation identifies and accounts for at least one airborne segment. The computed overall trajectory, the starting direction, and the initial velocity of the ball are provided.

This application is a continuation-in-part of U.S. patent application Ser. No. 16/728,967 filed Dec. 27, 2019, which claims the benefit of U.S. Provisional Patent Application Ser. No. 62/872,690, filed Jul. 10, 2019, which are hereby incorporated by reference in its entirety.

### FIELD

This technology generally relates to golfing aid systems and methods and more particularly to golfing aid systems and methods that compute a path or trajectory of a golf ball rolling, skidding, skipping, or bouncing on a surface.

### BACKGROUND

The prevalence and utility of golfing aids has increased dramatically in recent years, due to the availability of low-cost electronics, optics, and digital processors which have expanded the availability and usefulness of electronic displays, rangefinders, and even 3D cameras. These devices in turn have proven beneficial as training devices from tee shots to putts and every type of golf shot in between.

The art of putting is especially difficult to master, as a putt is subject to a host of variables beyond the golfers control, such as the direction and magnitude of the wind, the topography and slope of the green, the grain of the green, the speed (or resistance) of the green, and even the wetness or moisture content of the green. Most golfing aids do not capture and process half of these variables, and even when they do the variable data that is processed is imprecise and the algorithms that are executed are simplifications.

An example of a golf putting aid found in the prior art is illustrated in FIG. 1. As seen in FIG. 1, a golf putting-aid system 1 can comprise a camera 7 coupled to a digital processor 6 by way of an image data line 9, a display 10 also coupled to digital processor 6 that is capable of presenting imagery or data to a user or golfer (not shown in FIG. 1) operating golf putting-aid system 1, wherein camera 7 is a conventional electronic two-dimensional image-capturing device that has an associated field of view 8 that encompasses a golf green 2, a cup 3, and golf ball 4 that is intended to be shot into the cup 3.

In operation, the user or golfer operating the golf putting-aid system 1 initiates the putting-aid process after which digital processor 6 causes camera 7 to capture an image within the field of view 8 of the putting setup which includes the golf green 2, the ball 4, and the cup 3, whereinafter the camera 7 outputs the two-dimensional captured image to the digital processor 6. Digital processor 6 then performs various geometric and photogrammetric calculations with the captured two-dimensional image and computes a trajectory or path 5 that golf ball 4 can follow during the course of a putt to reach and drop into cup 3. An image of the notional trajectory 5 can then be superimposed by digital processor 6 onto the original image captured by camera 7, after which the modified image can be output onto display 10 for use by a golfer in planning or laying out his or her putt.

The prior art golf-putting aid system 1 has numerous deficiencies, including the use of processing a two-dimensional image of the three-dimensional geometry of the setup, and trying to deduce three-dimensional constructs of the setup, including the topography of the green 2, that are needed in order to compute an accurate trajectory 5. Further, golf-putting aid system 1 does not have sensors needed for determining the direction and velocity of the wind, nor for determining the grain and rolling resistance of the green, all of which are required for accurately determining trajectory 64. Further, prior art golf-putting aid system 1 does not have the capabilities of capturing imagery—preferably three-dimensional imagery—of a golfer's practice swing of a practice putt, from which not only the on-green trajectory of golf ball 4 can be computed (and evaluated to determine if the notional trajectory can cause the golf ball 4 to reach the cup 3) but also the vertical, or off-green path of the golf ball 4 can be determined—based on whether the face of the putting head is “open” or “closed”—which can cause the golf ball 4 to bounce, skip, or skid along the green 2 during the putt which can significantly change the course of the trajectory 5.

### SUMMARY

An electronic golfing aid system includes an image capturing device and an interface system coupled to at least one processor and a memory coupled to the processor which is configured to be capable of executing programmed instructions comprising and stored in the memory to capture, with the image capture device, image data comprising at least one of a playing surface, a ball, or a designated location spaced from the ball on the playing surface. At least one type of spatial data and at least one type of playing surface data relating to the playing surface, the ball and the designated location is determined. An overall trajectory, a starting direction, and an initial velocity of the ball to reach the designated location is computed, wherein the computation identifies and accounts for at least one airborne segment. The computed overall trajectory, the starting direction, and the initial velocity of the ball are provide with the interface system.

A non-transitory computer readable medium having stored thereon instructions comprising executable code which when executed by at least one processor, cause the processor to obtain image data comprising at least one of a playing surface, a ball, or a designated location spaced from the ball on the playing surface. At least one type of spatial data and at least one type of playing surface data relating to the playing surface, the ball and the designated location is determined. An overall trajectory, a starting direction, and an initial velocity of the ball to reach the designated location is computed, wherein the computation identifies and accounts for at least one airborne segment. The computed overall trajectory, the starting direction, and the initial velocity of the ball are provided.

A method comprising capturing, by an image capture device coupled to a computing device, image data comprising at least one of a playing surface, a ball, or a designated location spaced from the ball on the playing surface. At least one type of spatial data and at least one type of playing surface data relating to the playing surface, the ball and the designated location is determined by the computing device. An overall trajectory, a starting direction, and an initial velocity of the ball to reach the designated location is computed by the computing device, wherein the computation identifies and accounts for at least one airborne segment. The computed overall trajectory, the starting direction, and the initial velocity of the ball are provided by the computing device.

Accordingly, examples of the claimed technology provide a number of advantages including providing more accurate and effective golfing aid systems and methods. Examples of the claimed technology accurately compute a trajectory of a golf ball, such as a curved or piecewise linear trajectory, or a trajectory that includes bounces, skids, or skips in addition to rolling, of a putt along (or above) a playing surface, such as a golf green, taking into account a number of factors, such the topography of the green, the speed or resistance of the green surface, the distance between the ball and the cup, and/or the initial speed of the golf ball by way of example. Additionally, examples of the claimed technology provide guidance feedback data to assist with correlating the computed trajectory to an actual swing of a golf putter to match the trajectory.

### BRIEF DESCRIPTION OF THE DRAWINGS

FIG. 1 is a block diagram of a prior art golf putting aid system;

FIG. 2 is an orthographic view of an example of a golf green and a block diagram of an example of a golf putting aid system;

FIG. 3 is another orthographic view of the example of the golf green shown in FIG. 2 and example of computed piecewise linear trajectory of a golf ball having segments that are substantially equal in length;

FIG. 4 is another orthographic view of the example of the golf green shown in FIG. 2 in which the computed piecewise linear trajectory of a golf ball is comprised of segments that vary in length;

FIG. 5 is another orthographic view of the example of the golf green shown in FIG. 2 in which the computed segments comprising a trajectory of a golf ball are not linear;

FIG. 6 is a flow chart of an example of a method for computing the trajectory of a golf ball on a golf green;

FIG. 7 is a flow chart of an example of a method for using the golf putting aid system shown in FIG. 2;

FIG. 8A is a side-view diagram of an example of the golf ball on a portion of the golf green shown in FIGS. 2 through 5 illustrating examples of forces acting on the golf ball;

FIG. 8B is a plan-view diagram of an example of the golf ball on a portion of another golf green illustrating examples of forces acting on the golf ball;

FIG. 9 is a screenshot of an example of a graphical user interface that visually conveys a direction and magnitude of a practice putt swing and how the direction and magnitude compare to a computed direction and magnitude along with the golf ball on yet another golf green;

FIG. 10 is an illustration of a computed aim point displayed to a golfer in accordance with examples of this technology such that the ball reaches the cup when putted;

FIG. 11 is a side-view illustration of an example of a trajectory in which the golf ball skips or bounces in which in some segments the golf ball is not in contact with the green;

FIG. 12 is a side-view illustration of the change of angular momentum and translational momentum a golf ball undergoes when it bounces or skips on a green;

FIG. 13 is a side-view illustration of an example trajectory a golf ball can undergo when putted with an open-faced putter;

FIG. 14 is a side-view illustration of an example trajectory a golf ball can undergo when putted with a close-faced putter; and

FIG. 15 is an illustration of an example trajectory of a golf ball in which the putting surface has a discontinuity and in which the physical properties of the surface are different on each side of the discontinuity.

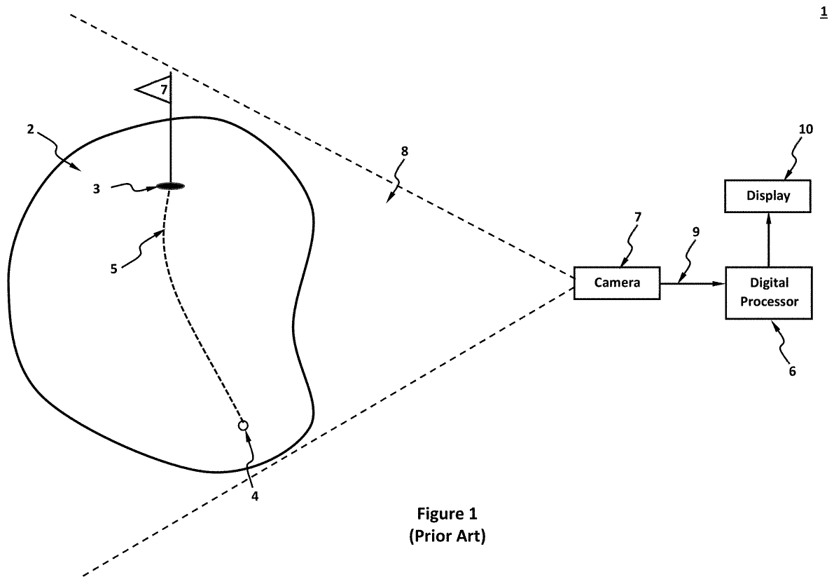

### DETAILED DESCRIPTION

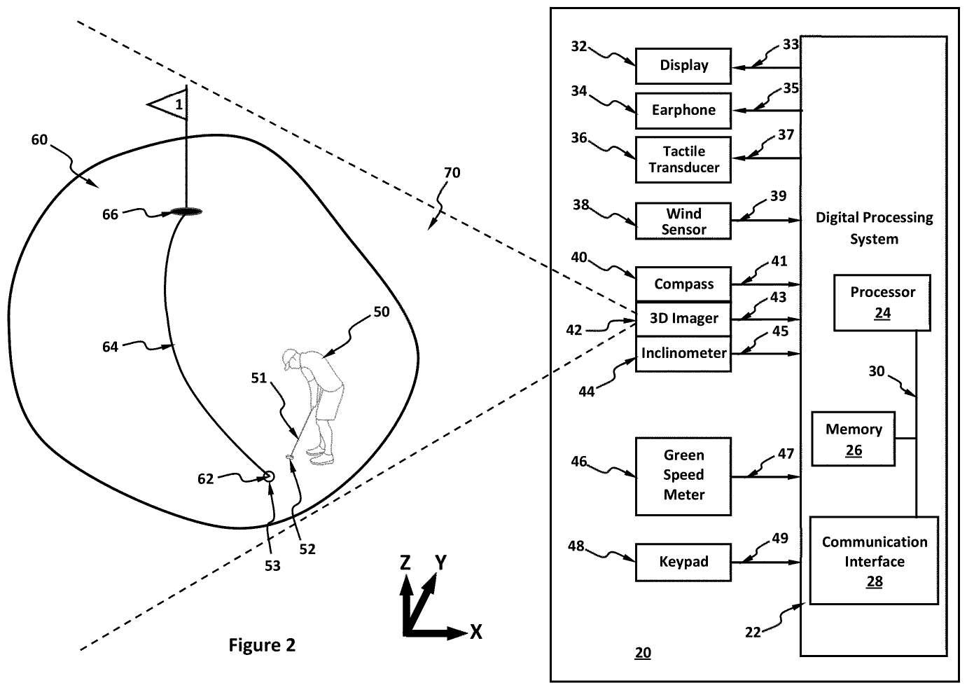

A golf putting aid system 20 in accordance with examples of the claimed technology is illustrated in FIG. 2. The golf putting aid system 20 includes a digital processing system 22, a keypad 48, a green speed meter device 46, an inclinometer device 44, a 3D imager device 42, a compass device 40, a wind sensor device 38, a tactile transducer 36, an earphone device 34, and a display device 32, although the golf putting aid system 20 can have other types and/or other numbers of other system, devices, components, or other elements in other configurations. Additionally, one or more of these elements of the golf aid putting system 20 may be integrated with the golf putting aid system 20 or separate from but coupled to the golf putting aid system 20. The claimed technology provides a number of advantages including providing more accurate and effective golfing aid systems and methods. In particular, examples of the golf putting aid systems and methods are configured to compute a trajectory, such as a curved or piecewise linear trajectory including segments where the golf ball is rolling, bouncing, skidding, skipping or otherwise airborne at least slightly so the ball is not rolling along the trajectory, of a putt along a playing surface, such as a golf green, taking into account multiple factors, such as the topography of the green, the speed or resistance of the green, the distance between the golf ball and the cup, and/or the initial speed of the golf ball by way of example.

Referring more specifically to FIG. 2, in this example the golf putting aid system 20 is operative with an exemplary golf green 60 having a golf ball 53, a cup 66, and a golfer 50 having a putter 51 which in turn has a putting head 52. A coordinate reference system is also illustrated in FIG. 2 in which the Z-axis is in the vertical or upwards direction, and the X and Y axes define the horizontal plane (note that X, Y, and Z axes are perpendicular to one another). The selection of the origin is arbitrary and in this example is at the location of the golf ball 53 on the golf green 60. The direction of the X-axis is also arbitrary and can be selected to be the direction from the golf ball 53 to the cup 66, projected onto the horizontal plane.

The digital processing system 22 includes a processor 24, a memory 26, and a communication interface 28 which are coupled together by one or more buses or other links 30, although the digital processing system 22 can have other types and/or numbers of other systems, devices, components, or other elements in other configurations. The processor 24 may execute programmed instructions stored in the memory 26 or elsewhere for any number of the functions and/or other operations illustrated and/or described by way of the examples herein. The processor 24 may include one or more CPUs or general purpose processors with one or more processing cores, for example, although other types and/or numbers of processor(s) can be used.

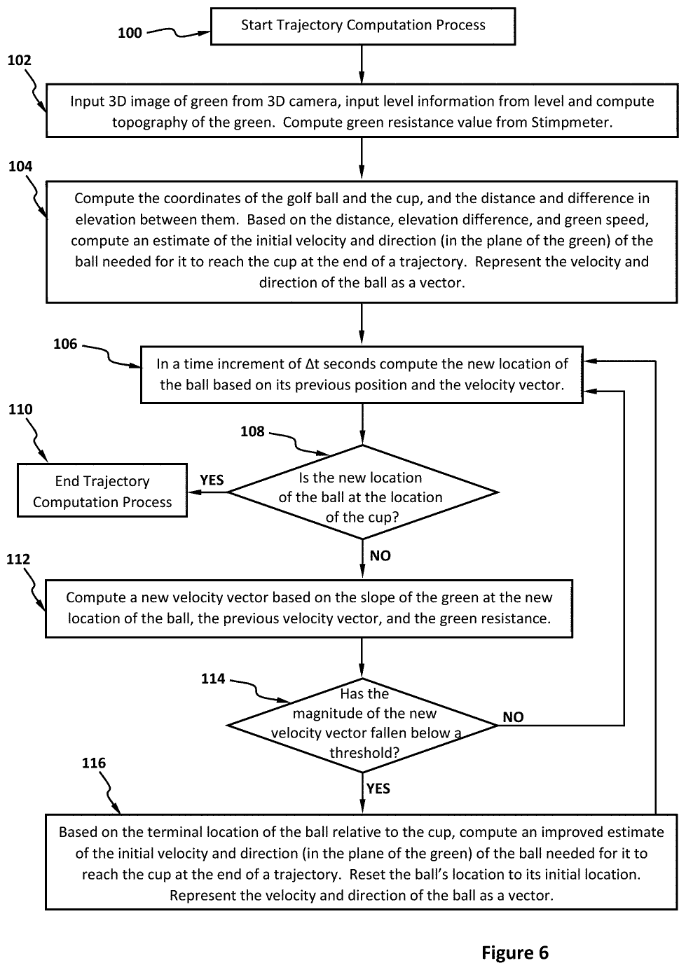

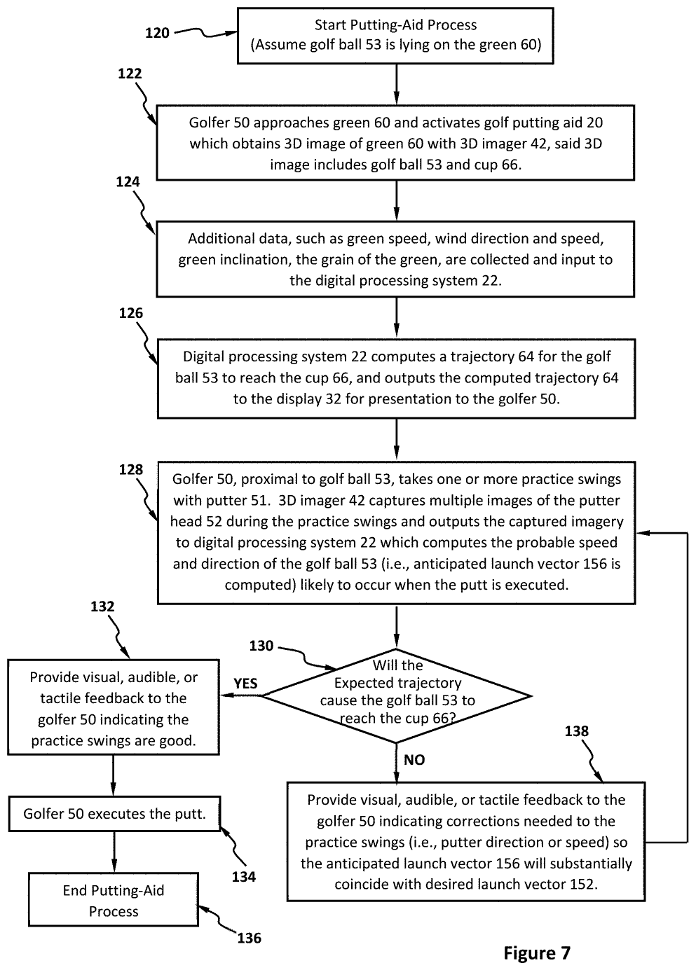

The memory 26 stores programmed instructions and data for functions and/or other operations illustrated and/or described by way of the examples herein for execution by the processor 24, although some or all of these instructions and data may be stored elsewhere. In this example, the memory 26 may store programmed instructions and data for computing or otherwise determining a computed trajectory 64 of a golf ball 53 on a green 60 as illustrated and described by way of the examples herein including in FIGS. 6 and 7. Additionally, in this example, the memory 26 may store programmed instructions and data for image processing to capture image data, such as one or more images and/or videos of a green 60 with a golf ball 53 and a cup 66, and object recognition processing to identify one or more objects in the one or more captured images and/or videos, such as the outer perimeter and contours of the green 6 as well as the golf ball 53 and cup 66. A variety of different types of memory storage devices, such as a random access memory (RANI), a read only memory (ROM), flash memory, hard disk, CD ROM, USB thumb-drive, or other computer readable medium which is read from and/or written to by a magnetic, optical, or other reading and/or writing system coupled to the processor 24, can be used for the memory 26.

The communication interface 28 operatively couples and communicates between the digital processing system 22 and one or more of the keypad 48, the green speed meter device 46, the inclinometer device 44, the 3D imager device 42, the compass device 40, the wind sensor device 38, the tactile transducer 36, the earphone device 34, and the display device 32 which are all coupled together by the one or more communication network(s) which may be direct internal or external hardwire connections and/or may by wireless connections, although other types and/or numbers of communication networks or systems with other types and/or numbers of connections and/or configurations to other devices and/or elements can be used.

By way of example only, the digital processing system 22 can be a conventional microprocessor with an external memory or the digital processing system 22 can be a microcontroller with all memory located onboard. In another example, the digital processing system 22 can be a digital signal processor (DSP) integrated circuit, which is a microcomputer that has been optimized for digital signal processing applications. In yet another example, the digital processing system 22 can include a graphical processing unit (GPU) integrated circuit, which is a microcomputer that has been optimized for parallel-processing applications. The digital processing system 22 could for example be as simple as an eight-bit integer device for low-cost usage or in another example the digital processing system 22 can be a thirty-two bit or sixty-four bit or higher floating point device or system for higher performance when cost is less of an issue. Also, by way of example only, the digital processing system 22 can be or can include an FPGA (Field-programmable gate array), a CPLD (complex programmable logic device), or even an ASIC (application specific integrated circuit) which are attractive for use in this example owing to their compact and cost-effective hardware implementations.

The keypad 48 is a data entry device for manually entering data into golf putting aid 20, such as, for example, data pertaining to the grain of a green 60, although other types and/or numbers of input devices or systems may be used, such as voice activated by way of example. The keypad 48 has an output electronically coupled to an input of digital processing system 22 through keypad data line 39, although other types of connections may be used, including for example other wired or wireless connections. The keypad 48 can be a full QWERTY-style keyboard or have a 12-key phone-style layout, or any other layout suitable for entering numeric, alphanumeric, symbolic, or iconic data. The keys can be soft keys, such as used in a touch-display (in which case, for example, keypad 48 can be integrated with display device 32) or hard keys in which they implemented electro-mechanically.

The green speed meter device 46 is a device for measuring the speed, or more precisely, in one example a resistance a playing surface of the green 60 offers to a golf ball 53 rolling across it. The green speed meter device 46 has an output electronically coupled to an input of digital processing system 22 via speed meter data line 47, although other types of connections may be used, including for example other wired or wireless connections. By way of example, the green speed meter device 46 can be a device similar to an electronic version of the Stimpmeter (Stimpmeter is a registered trademark of the USGA, describing goods associated with an “apparatus for measuring the relative speed of a golf putting green.”) in which a golf ball 53 is rolled down an inclined plane before reaching the surface of a green 60 whereinafter the distance the golf ball 53 rolls after reaching the green 60 is indicative of the green's speed and inversely proportionate to the rolling resistance of the golf ball 53 across the surface of the green 60. Since both terms, “resistance” and “speed”, refer to the same quantity of a golf green, namely how quickly a rolling golf ball's velocity decreases as it rolls across a surface of the green, the terms will be used interchangeably in the present disclosure even though, technically, they have distinct and separate physical definitions. The resistance the green 60 offers to the golf ball 53 as it rolls on a green 60 is an example of an input parameter when computing a trajectory as illustrated and described in examples herein. For example, if the green's resistance was zero the golf ball 53 will roll forever, and if the resistance was infinite the golf ball 53 would not roll at all. In other examples, the green speed and/or resistance data may be obtained by the digital processing system 22 in other manners, such as by manual input by keypad 48 or by coupling to and retrieving from a database which has this green speed and/or resistance data stored, e.g. a server at the golf course, or may obtain prior stored green speed and/or resistance data which can be used as an approximation by way of example only.

The inclinometer device 44 (also referred to herein as a level) is nominally mechanically coupled to 3D imager device 42 and outputs inclination or tilt information, such as the front-to-back or side-to-side tilt, of the 3D imager device 42 to the digital processing system 22. The inclination or tilt information may be used, because, while the 3D imager device 42 can produce detailed topographical information about the surface of green 60, the topographical information can appear to be tilted if the 3D imager device 42 happens to be tilted during the 3D imaging process. The inclination data output from the inclinometer device 44 can be used by the digital processing system 22 to remove the effects of any inadvertent tilt introduced by the 3D imager device 42 being held, mounted, or otherwise oriented in a tilted manner. The inclinometer device 44 has an output electronically coupled to an input of digital processing system 22 via inclinometer data line 45, although other types of connections may be used, including for example other wired or wireless connections. The inclinometer device 44 can be an integrated circuit, such as the ADIS 16203 from Analog Devices, Inc. (Norwood, Mass., USA 02062), and the inclinometer device 44 can be attached to the 3D imager device 42 as mentioned earlier. Alternately, in another example the inclinometer device 44 can be mechanically integrated into the 3D imager device 42 or even electronically integrated into 3D imager device 42 so the 3D topographical image of the green 60 has had the tilt corrected thereby relieving the need of digital processing system 22 from performing the tilt correction, although other manners for obtaining this tilt data may be used.

The 3D imager device 42 is a device that captures or creates a 3D image of a target object, such as the surface of a golf green 60, although other manners for capturing or otherwise obtaining 3D image data or other types of image data may be used. The 3D imager device 42 has a field of view 70 and an output electronically coupled to an input of digital processing system 22 via 3D camera data line 41, although other types of connections may be used, including for example other wired or wireless connections. The 3D imager device 42 can be an active device such as a time-of-flight (“TOF”) range camera in which the entire field of view 70 is illuminated with modulated light emitted by the range camera which subsequently receives back a portion of the emitted light, and process the received light to determine a distance to a small patch of the surface for each corresponding pixel of the 3D imager 40. Alternately, the 3D imager device 42 can include a scanning LIDAR (light detection and ranging) or utilize projected structured light, and although passive 3D imagers, such as those based on stereoscopic cameras can be used as 3D imager 40, stereoscopic methods are probably unsuitable because the golf green's 60 surface is generally featureless which precludes the generation and processing of a stereoscopic disparity matrix from which the topography of the green 60 can be determined.

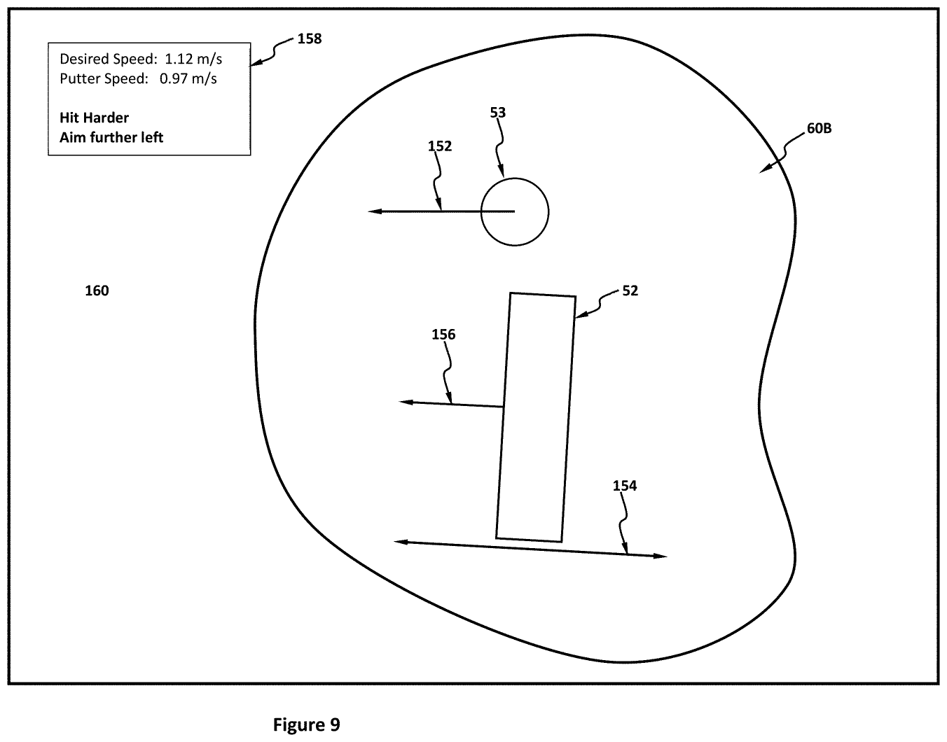

The 3D imager device 42 outputs a digital representation of the 3D surface of the green 60 to digital processing system 22. In this example, the 3D coordinate system used in the representation can be Cartesian, such as the X-Y-Z axes denoted in FIG. 2, or p-θ-ϕ coordinates commonly used in a spherical coordinate system. The digital representation can include an array of pixels, wherein the number of pixels is between 1000 and 100,000,00, and there can be one or more such 3D images captured and uploaded to the digital processing system 22. If more than one 3D image is captured and uploaded, the 3D image capture rate can be between one 3D image per second and 1000 3D frames per second. Such 3D video imagery can be useful for determining putter head direction 192 or putter head direction 202 from which an anticipated launch vector 156 can be determined as described later in connection with FIGS. 13, 14, and 9, which requires a sequence of 3D image frames for the determinations. The 3D imager device 42 can also output a conventional 2D brightness image of the surface, the 2D image being monochrome or in color. The 3D imager device 42 can be a portable device, being held by the golfer 50 (or his or her caddy) or even attached to the golfer 50 (or attached to his or her caddy), or substantially fixed in place where the 3D imager device 42 is mounted onto a tripod or a rigid frame or gantry.

The compass device 40 is an electronic device for measuring and obtaining direction information that may be electronically communicated to digital processing system 22. In this example, the compass device 40 has an output electronically coupled to an input of digital processing system 22 via compass data line 41, although other types of connections may be used, including for example other wired or wireless connections. Additionally in this example, the compass device 40 also is nominally co-located with 3D imager 40, or in other examples mechanically coupled to 3D imager device 42 so the heading information output from compass device 40 is, for example, indicative of the direction that 3D imager device 42 is aimed. One candidate for use as the compass device 40 is the HMC6343 Three-axis Compass from Honeywell (Plymouth, Minn., 55441 USA), which has 0.1° resolution and can measure both heading and tilt. The directional or heading information output from compass device 40 can be used by digital processing system 22 to change the perspective viewing angle of the information or image data, such as an image of a computed trajectory 64, presented on display device 32 in accordance with the heading information from compass device 40.

The wind sensor device 38 is a device for measuring the magnitude and direction of the wind at or near the location of the golf ball 53, so the trajectory-computation, discussed by way of example below with reference to FIG. 6, can include the forces imparted on the golf ball 53 by the wind when determining a golf ball's 53 computed trajectory 64. The wind sensor device 38 has an output electronically coupled to an input of digital processing system 22 via wind sensor data line 39, although other types of connections may be used, including for example other wired or wireless connections. The wind sensor device 38 can include a weather-vane for determining wind direction and an anemometer for measuring wind speed, although other types of wind-sensing devices which measure one or more wind related characteristics can be utilized as well. In this example, the sensed wind information is communicated to the digital processing system 22 for inclusion in the determination of computed trajectory 64. The wind sensor device 38 can be small and portable or larger and fixed in position. By way of example only, both wind direction and wind speed sensors are available from C-TON Industries (e.g., model number DLT and SLT, respectively) Memphis, Tenn., USA, 38111. Although in this example wind speed and/or direction data is obtained and utilized, other types and/or numbers of other types of weather related data may be obtained and utilized for computing trajectory, such as current weather condition data.

The tactile transducer 36 is an electro-mechanical device that creates a mechanical sensation that can be detected by a person, such as a golfer 50. The tactile transducer 36 has an input electronically coupled to an output of digital processing system 22 via tactile transducer data line 37, although other types of connections may be used, including for example other wired or wireless connections. In this example, the tactile transducer 36 is constructed as a small electrical motor with an off-balance weight attached to the shaft such that it produces a vibrational sensation when activated and is wirelessly coupled to the digital processing system 22, although a tactile transducer can be constructed from other types of components in other configurations and may be coupled to communicate in other manners. The tactile transducer 36 can be located in the handle of putter 51, or co-located with a display device 32 or earphone device 34, but is beneficially located proximal to, and even in physical contact with, golfer 50 to sense the tactile sensations produced by the tactile transducer 36. In this example a tactile transducer 36 can be activated by digital processing system 22 when the aim of the golfer's 50 putter 51 or putter head 52 is positioned correctly or the practice swing is substantially correct as determined by digital processing system 22 so that the golf ball 53 can be expected to follow computed trajectory 64 so the ball 53 reaches the cup 66 when the golfer 50 executes the putt. One tactile transducer 36 suitable for use in this example is the Z4FC1B1301781 from Jinlong Machinery and Electronics, Yueqing Whenzhou, Zhejiang Province, China 325603.

The earphone device 34 is an electro-mechanical device that produces audio signals in response to applied electronic signals and are typically worn by a golfer 50 in his or her ear(s). The earphone device 34 has an input electronically coupled to an output of digital processing system 22 via earphone data line 35, although other types of connections may be used, including for example other wired or wireless connections. In this example, the earphone device 34 can be activated by digital processing system 22 when the aim of the golfer's 52 putter 51 is to the left, for example, as determined by digital processing system 22 (so that the golf ball 53 can be expected to follow a trajectory to the left of computed trajectory 64 when the golfer 50 executes the putt) in which case the earphone can produce the audible message “Aim Right More” for putter aim feedback and correction, although earphone can be activated at other times and produce other types and/or numbers of audible instruction messages from a stored library of guidance instructions as well. By way of example, one pair of earphones 34 suitable for use in this example is the UH-R 2030 from USound GmbH, Graz, Austria.

The display device 32 can be a head-mounted display in which the display device 32 is attached to the golfer's 52 head located proximal to the eyes of the golfer 50 so that an image is presented to one or both eyes of the golfer 50 from an image generated by the digital processing system 22, although other types and/or numbers of other types of display devices or manners may be used. If no outside image data is allowed to be directly seen by golfer 50 (i.e., only the display image data is viewable), then the display device 32 is immersive. Immersive displays as well as non-immersive displays are suitable for use as the display device 32. In another example, the display device 32 can comprise two individual displays offset from one another, thus forming a stereoscopic pair in which one sub-display presents an image to one eye and the second sub-display presents a slightly different image to the second eye such that 3D image data can be stereoscopically presented to the golfer 50. In yet another example, the display device 32 can be a large non-head-mounted conventional display which in this example is wireless connected to the digital processing system 22 and in which the displayed image data may be viewed by the golfer 50 from a distance of at least 12 inches or more. In this example, the display device 32 has an input electronically coupled to an output of digital processing system 22 via display data line 33, although other types of connections may be used, including for example other wired or wireless connections. In yet another example, the display device 32 can be the display of a smart-phone,

The image data that is shown on the display device 32 can include the image data within the field of view 70 captured by 3D imager device 42, such as the green 60, the ball 53, the cup 66, one or computed trajectories 64, topography information of the green 60, gradient information of the green 60, an indication of the aiming point or direction that the golf putt should be shot by the golfer 50, as well as the actual putt trajectory whose image data was captured during the putting process. Furthermore, any or all of this display content can be presented in real-time to the golfer, as well as to a larger audience, and can vary in accordance with location and/or point of view and the viewing direction of the golfer 50.

In this example, the field of view 70 is the viewing angle of the 3D imager device 42 over which 3D image data can be captured. Within the field of view 70 should be at least the area of the green 60 of interest, the ball 53, the cup 66, and that portion of the green 60 between them that the golf ball 53 will traverse from the golf ball's starting position 62 to its stopping position, although the other types and/or required numbers of elements may be used. The digital processing system 22 may execute programmed instructions for object recognition to identify necessary elements in the image data, e.g. the green, ball and cup, and if not identified, then the digital processing system 22 may interact with the 3D imager to continue to capture image data until the object recognition is able to verify the presence of the necessary elements, e.g. the green, ball and cup.

As noted in the examples above, some or all of the electronic data links including the keypad data line 49, the speed meter data line 47, the inclinometer data line 45, the 3D camera data line 43, the compass date line 41, the wind sensor data line 39, the tactile transducer data line 37, the earphone data line 35, and the display data line 33 can be wireless or wired in nature. If wireless, the data links for example can be Bluetooth or Wifi. If wired the data links for example can comprise electronic conductors or even fiber optics.

Optionally digital processing system 22 can also obtain captured and recorded image data of the action of the putter head 52 during the stroke, the initial direction and velocity of the ball 53, and the actual trajectory of the ball from the start of the putt until the ball 53 comes to a stop. This recording of this image data, comprising video and/or images, can be re-played at a later time as a feedback mechanism so the golfer 50 can learn and improve his or her putting game.

The examples illustrated and described herein may also be embodied as one or more non-transitory computer readable media having instructions stored thereon for one or more aspects of the present technology, such as the memory of the assessment computing device, as described and illustrated by way of the examples herein. The instructions in some examples include executable code that, when executed by one or more processors, such as the processor(s) of the assessment computing device, cause the one or more processors to carry out steps necessary to implement the methods of the examples of this technology that are described and illustrated herein.

An example of a method of trajectory computing executed by the digital processing system 22 functions by approximating an actual continuous trajectory as a series of short, straight, line segments, although other manners for computing trajectory may be used. As the length of the line segments approaches zero, the computed trajectory 64 will also be continuous and substantially match the actual trajectory. Unfortunately, if the length of each of the line segments is zero, then there must necessarily be an infinite number of segments which is not realizable. In this example, a reasonable number of segments is between ten and 10,000 (depending primarily on the overall length of the trajectory) and in this example the length of a segment can be between 0.1 millimeter and one meter, although other numbers of segments and/or other lengths may be used.

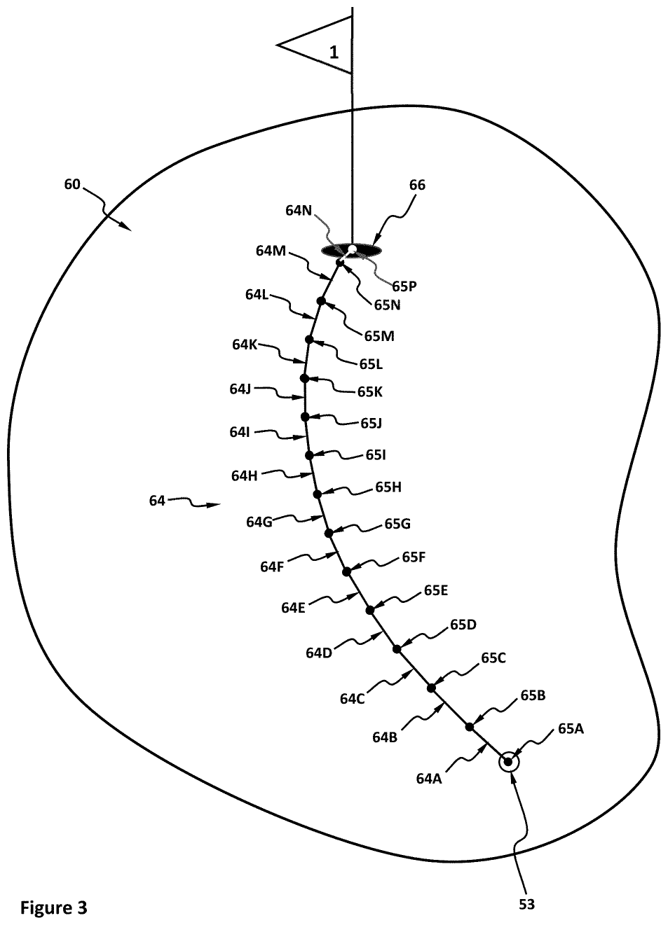

Referring now to FIG. 3, an example of a computed trajectory 64 is shown as a series of linear segments, 64A, 64B, 64C, and so on, each segment having a starting point and an ending point. For example, the starting point for a first segment 64A is point 65A, coinciding with ball starting position 62, and the ending point for first segment 64A is point 65B, while the starting point for second segment 64B is point 65B and the ending point for second segment 64B is point 65C. Each segment, 64A, 64B, 64C, and so on, comprising the computed trajectory 64 can lie on the surface of the green 60, or slightly above the green's 60 surface in accordance with the radius of the golf ball 53, the radius can be between one millimeter and ten meters, but being 21.335 millimeters for a standard golf ball.

Each segment of a trajectory 64 can be treated as a vector because a segment has a starting position and a velocity and direction of travel. Using vector arithmetic, the ending position of a segment is therefore the starting position plus the velocity vector times a time increment, the time increment being between one millisecond and one second, for example. A velocity vector is computed as the velocity vector of a previous segment plus a change in velocity due to the rolling resistance of the green 60 plus an additional change in velocity due to gravity which in turn is a function of the topography—more precisely the gradient of the topography—of the green 60 at the location of the starting position of the velocity vector. Additional influences on the velocity vector, such as accelerations due to forces caused by the wind or any biases of the green 60 such as grain by way of example only, may be incorporated into the calculation of the velocity vector.

One noteworthy feature of the segments comprising computed trajectory 64 as shown in FIG. 3, is that the segments, such as segments 64A through 64M, are all substantially linear and all have substantially the same length. The length of the linear segments, when projected on the green 60, can be between 1 mm and 1 meter. The fact that the segments all have substantially the same length implies that the length of time, or duration, that a golf ball 53 is moving along a segment varies from segment to segment because, generally, a golf ball 53 is slowing down as it traverses a computed trajectory 64, meaning that generally a golf ball 53 will spend more time moving along a later segments, such as segment 64M than an earlier segment such as segment 64B. The time a golf ball can spend in a given segment can vary from 1 millisecond up to 1000 millisecond. Importantly, the trajectory computation process as described in connection with FIG. 6 can take into account the linearity of the segments, the substantially constant length of the segments, and the varying times that a golf ball requires to traverse a segment, when a computed trajectory 64 is determined.

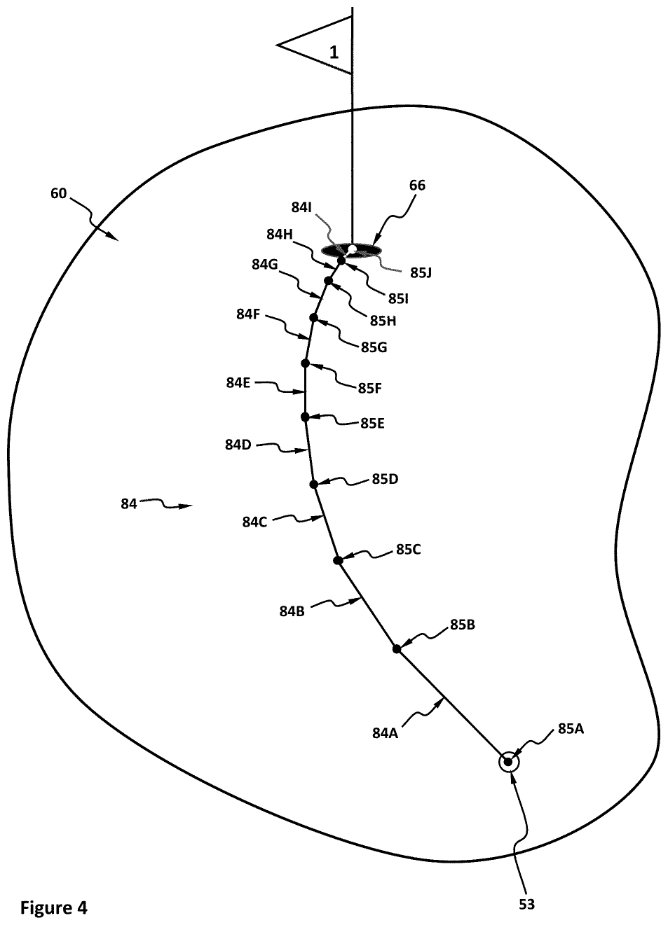

Alternately, as shown in FIG. 4, the segments, such as segments 84A through 84H, are all substantially linear but do not all have substantially the same length. The length of the linear segments, such as segments 84A through 84H, when projected on the green 60, can be between 1 mm and 1 meter. The fact that the segments have varying lengths, with shorter lengths seen at the end of trajectory 84, implies that the length of time, or duration, that a golf ball 53 is moving along a given segment can be substantially constant from segment to segment because, generally, a golf ball 53 is slowing down as it traverses a computed trajectory 84, meaning that generally a golf ball 53 will move a shorter distance along a later segment, such as segment 84H than an earlier segment such as segment 84A. The time a golf ball can spend in each segment can range from 1 millisecond up to 1000 millisecond. Importantly, the trajectory computation process as described in connection with FIG. 6 can take into account the linearity of the segments, the varying lengths of the segments along trajectory 84, and the substantially constant amount of time that a golf ball 53 requires to traverse a segment, when a computed trajectory 84 is determined.

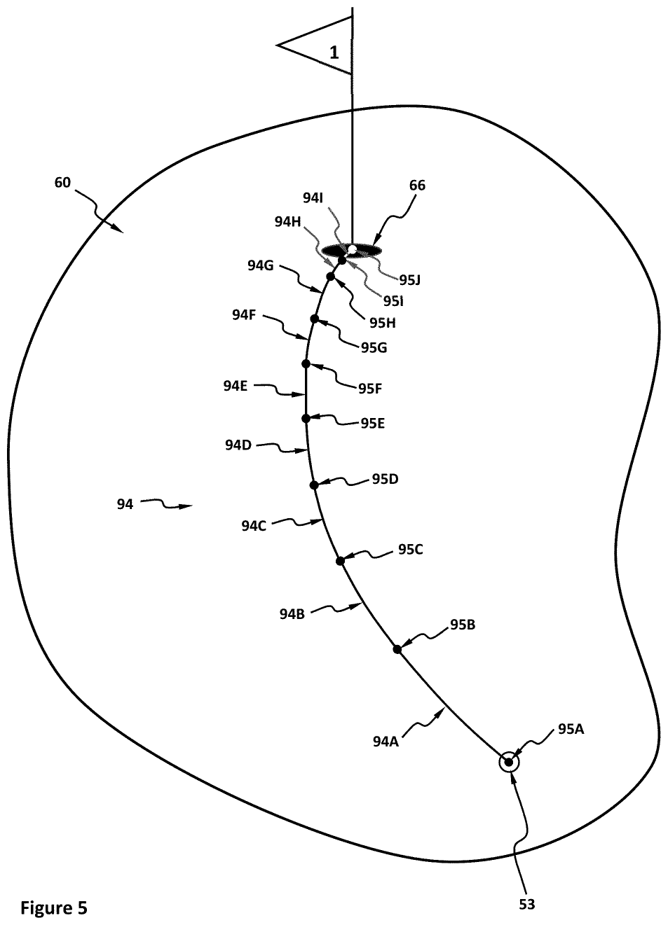

Alternately, as shown in FIG. 5, the segments, such as segments 94A through 94H, can be non-linear, and not all have substantially the same length as depicted in FIG. 5, or have substantially the same length as described earlier in connection with FIG. 3. The arcuate length of the non-linear segments, such as segments 94A through 94H, when projected on the green 60, can be between 1 mm and 1 meter. The length of time a golf ball 53 is moving along a given non-linear segment can be substantially constant from segment to segment (as described in connection with FIG. 3) or the length of time a golf ball 53 is moving along a given non-linear segment can vary from segment to segment (as described in connection with FIG. 4). The non-linear segments, such as segments 94A through 94H can each be mathematically described as a polynomial, such as a second-order polynomial, or the polynomials can include higher-order terms up to 10^{th}-order. Importantly, the trajectory computation process as described in connection with FIG. 6 can take into account the nonlinearity shapes of the segments when a computed trajectory 84 is determined. Note that the nonlinearity can be in the X and/or Y directions, as well as in the Z (up-down) direction if the golf ball 53 is bouncing, skidding, skipping or otherwise airborne at least slightly so the ball is not rolling along the trajectory.

Referring now to FIG. 6, an example of a method for computing a computed trajectory 64 based on a series of line segments will now be described. In step 100, the golf putting aid system 20 is activated.

In step 102, the digital processing system 22 of the golf putting aid system 20 receives 3D image data which in this example is determined with object recognition to include the green 60, the golf ball 53 and the cup 66 from the 3D imager device 42, 3D camera inclination data from inclinometer device 44, green speed data on the resistance of the green to a rolling golf ball obtained from a green speed meter device 46, such as a Stimpmeter, and input with the keypad 48 or based on a coupling to the green speed meter device 46, weather element data about a direction and magnitude of the wind from the wind sensor device 38, and the grain of the grass on the surface of the green 60 which can be manually input via keypad 48, although other types and/or combinations of data to compute a trajectory may be used. Next, the digital processing system 22 computes a topographic map of the green 60 within a field of view 70 of the 3D imager device, and also computes a gradient map of the green 60 as well which is essentially a vectorized slope map of the topographic map. After the gradient and topographic maps are computed, and all the data is input to the digital processing system 22, the data may be stored in memory 26 in this example.

In step 104, several initializing computations are performed by the digital processing system 22 of the golf putting aid system 20, such as computing the coordinates of the cup 66 in two dimensions (i.e., X_{C},Y_{C}) or three dimensions (i.e., X_{C},Y_{C}, Z_{C}) relative to the golf ball 53—in particular the elevation of the cup 66 relative to the elevation of the golf ball 53, and the distance between them. Based on the distance and the difference in elevation, as well as, optionally, the speed or resistance of the green 60 and any other parameters that would influence the computed trajectory 64 of the golf ball 53, digital processing system 22 of the golf putting aid system 20 then computes in this example an estimated initial direction and velocity of the golf ball 53 such that the resulting computed trajectory 64 of the golf ball 53 will terminate at the cup 66. The velocity and direction estimate of the golf ball 53 at each trajectory segment can be represented mathematically as a vector, the “velocity vector”, V, for easier mathematical processing by the digital processing system 22. The velocity vector V, can be represented as V=Vₓi+V_{y}j+V_{z}k, where i, j, and k are unit vectors in the X, Y, and Z directions, respectively, and Vₓ, V_{y}, and V, having units of meters per second for example, are the components of the velocity vector V in the X, Y, and Z directions, respectively. Note that the magnitude of the velocity vector, V, can be computed from its directional components, V_{X}, V_{y}, and V, as:

|V|=\sqrt{Vₓ²+V_{y}²+V_{z}²} Equation 1

In step 106, the digital processing system 22 of the golf putting aid system 20 determines where the golf ball 53 will be on green 60 in a time Δt in the future based on the present location of the golf ball 53 and the present value of the velocity vector V. In particular, if X_{S} is the starting position of a trajectory segment and X_{E} is the ending position of a trajectory segment in the X-direction then X_{E}=X_{S}+VₓΔt. Similarly, if Y_{S} is the starting position of a trajectory segment and Y_{E} is the ending position of a trajectory segment in the Y-direction then Y_{E}=Y_{S}+V_{y}Δt. The ending point for the ball in the Z-axis for the same trajectory segment is determined by the topography of the green 60, determined earlier in step 102, as the golf ball 53 is assumed to follow the topography or contours of the green 60 if the golf ball 53 is not bouncing.

In step 108, the digital processing system 22 of the golf putting aid system 20 determines if the location of the golf ball 53 at the coordinates at the end of the segment, namely (X_{E},Y_{E}) computed in step 106 is substantially the same as the coordinates of the cup, (X_{C},Y_{C}) computed in step 104. Mathematically this determination can be computed as

D=(X_{E}−X_{C})²+(Y_{E}−Y_{C})² Equation 2

where D is the distance between the center of the golf ball 53 and the center of the cup 66.

If in step 108 the digital processing system 22 of the golf putting aid system 20 determines the location of the golf ball 53 at the coordinates at the end of the segment, namely (X_{E},Y_{E}) computed in step 106 is substantially the same as the coordinates of the cup, (X_{C},Y_{C}) computed in step 104, e.g. in this example when value of D is less than a threshold value, such as 0.010 meters, then the golf ball 53 has reached the cup 66 and the Yes branch is taken to step 110.

In step 110, a trajectory 64 for the golf ball 53 that causes the golf ball 53 to reach or land in the cup 66 has been computed by the digital processing system 22 of the golf putting aid system 20. Therefore, in the digital processing system 22 of the golf putting aid system 20 may stop computing trajectory, until another new trajectory is needed.

If back in step 108 the digital processing system 22 of the golf putting aid system 20 determines the location of the golf ball 53 at the coordinates at the end of the segment, namely (X_{E},Y_{E}) computed in step 106 is not substantially the same as the coordinates of the cup, (X_{C},Y_{C}) computed in step 104, e.g. if the value of D is greater than the threshold value then the golf ball 53 is not at the location of the cup 66 and the No branch is taken to step 112.

An additional test may be executed by the digital processing system 22 of the golf putting aid system 20 in step 108, wherein the digital processing system 22 of the golf putting aid system 20 determines if the velocity of the golf ball 53 is also less than a threshold velocity value, otherwise the golf ball 53 may be at the cup, but would jump over the cup 66 without falling into it if the velocity value is too great. The velocity is the magnitude of the velocity vector V, which is computed according to Equation 1. If the golf ball's 53 location is substantially at the location of the cup 66 (e.g., D is less than a threshold), and the velocity value of the golf ball 53 does not exceed the velocity threshold, such as 0.010 meters/second, for example, then the Yes branch would still be taken to step 110. However, if the golf ball's 53 location is substantially at the location of the cup 66 (e.g., D is less than a threshold), but the velocity value of the golf ball 53 exceeds the velocity threshold, such as 0.010 meters/second, for example, then the No branch would still be taken to step 112. It should be noted that in this disclosure the word “reach” or “reached” is defined to mean that not only has the position of the golf ball become substantially the same as that of the cup 66, but that also the velocity of the golf ball 53 is slow enough that the golf ball 53 can fall into the cup 66 at the position of the cup 66 instead of passing over the opening of the cup 66.

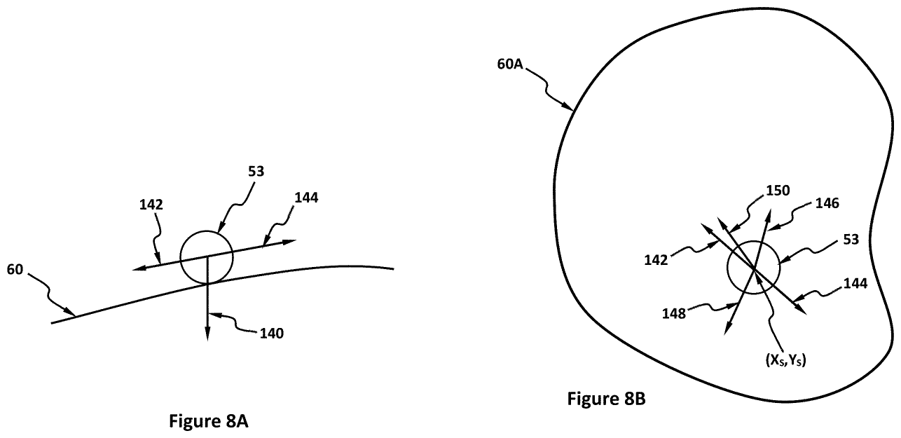

In step 112, the velocity vector V for the next trajectory segment is computed by the digital processing system 22 of the golf putting aid system 20. The starting coordinates (X_{S},Y_{S}) of the new velocity vector are set equal to the ending coordinates of the previous segment (X_{E},Y_{E}), i.e., X_{S}=X_{E} and Y_{S}=Y_{E}. Additionally in step 112, the direction and the magnitude of the new velocity vector may also be computed by the digital processing system 22 of the golf putting aid system 20, which is a function of the topography at location (X_{S},Y_{S}), the magnitude and direction of the previous velocity vector, the resistance offered by the surface of a green 60 to a rolling golf ball 53, and any other forces acting on the golf ball 53, such as the wind or grain of the green 60 at (X_{S},Y_{S}) by way of example only. Some of the possible forces that can be acting on the ball are shown vectorally in FIGS. 8A and 8B, and include gravity vector 140, which is in the downward direction but is manifested as the motion vector M 142 whose direction and magnitude includes the effects of gradient of the green 60 at (X_{S},Y_{S}) which is determined from the topography of the green 60, resistance vector R 144 which is in the negative direction of the velocity vector V, the wind vector W 148, and any biases or grains in the surface of the green 60 represented as grain vector N 124.

Each of the forces, being represented as a vector, has X, Y, and Z components that can be added with other X, Y, and Z components, respectively, to determine the total force acting on the ball in each component direction. For example, in the X-direction the forces can be added as

X_{Total}=X_{M}+X_{R}+X_{W}+X_{N} Equation 3

where X_{Total} is the sum total of the forces acting on the ball in the X-direction, X_{M} is the X-component of the motion vector M 142, X_{R} is the X-component of the resistance vector R 144, X_{W} is the X-component of the wind vector W 148, and X_{N} is the X-component of the grain vector N 124.

Similarly, the Y-direction forces acting on the ball sum as shown in Equation 4:

Y_{Total}=Y_{M}+Y_{R}+Y_{W}+Y_{N} Equation 4

Note that it is may not be necessary to compute the forces acting on the ball in the Z-direction, e.g., Z_{Total}, because the motion of the ball in the Z-direction is dictated by the topography of the green 60, unless, of course and by way of example, the ball is bouncing, skidding, skipping or otherwise airborne at least slightly so the ball is not rolling on the surface.

The acceleration of the ball at each starting point of a trajectory segment can be computed by the digital processing system 22 of the golf putting aid system 20 from the well-known equation:

Force=Mass×Acceleration. Equation 5

Note that in Equation 5 the Force term is a vector and the Acceleration term is also a vector, and as such can be split into their respective components as shown in Equations 6 and 7, and include the total component forces developed in Equations 3 and 4, respectively:

Force_{X}=Mass×Acceleration_{X}=X_{Total} Equation 6

Force_{Y}=Mass×Acceleration_{Y}=Y_{Total} Equation 7

Rearranging Equations 6 and 7 results in Equation 8 and 9, respectively:

Acceleration_{X}=K_{Total}/Mass Equation 8

Acceleration_{Y}=Y_{Total}/Mass Equation 9

If the time increment Δt is sufficiently small then the change in velocity due to the acceleration can be computed from equation 10:

V_{E}−V_{S}=ΔV=Acceleration×Δt. Equation 10

Equation 10 can be broken apart for each of the two X and Y components and combined with Equations 6 and 7, respectively, resulting in:

ΔV_{X}=X_{Total}Δt/Mass Equation 11

ΔV_{Y}=Y_{Total}Δt/Mass. Equation 12

where the Mass term is the mass of the golf ball 53, being approximately 0.0459 kilograms, and ΔV_{X} is the change in velocity in the X-direction and ΔV_{Y} is the change in velocity in the Y-direction. The components of the new velocity vector (i.e., of the next segment of the computed trajectory 64) is therefore

V_{X}=V_{E,X}+ΔV_{X}=V_{E,X}+X_{Total}Δt/Mass Equation 13

V_{Y}=V_{E,Y}+ΔV_{Y}=V_{E,Y}+Y_{Total}Δt/Mass Equation 14

The new velocity vector V computed in Step 112 of FIG. 6 is thus

V=V_{X}i+V_{Y}j Equation 15

After the new velocity vector is computed in step 112 per Equation 15, then in step 114, the digital processing system 22 of the golf putting aid system 20 determines if the magnitude of new velocity vector V, determined in accordance with Equation 15 and Equation 1, has fallen below a threshold velocity. That is, in step 114 the digital processing system 22 of the golf putting aid system 20 whether the golf ball 53 has essentially stopped rolling. If in step 114 the digital processing system 22 of the golf putting aid system 20 determines the magnitude of the new velocity vector V has not fallen below a threshold (i.e., it has not stopped rolling), then the No branch is taken back to step 106 as illustrated and described earlier. If in step 114 the digital processing system 22 of the golf putting aid system 20 determines the magnitude of the new velocity vector V has fallen below a threshold such as 2 mm/second, for example, then the Yes branch is taken to step 116. In step 116, when the ball 53 has stopped rolling (as determined in step 114) and it has missed or skipped over the cup 66 (as determined in step 108).

In step 116, the digital processing system 22 of the golf putting aid system 20 determines based on an analysis of image data captured by the 3D imager device 42 or in other manners the ending location of the computed trajectory 64 (i.e., X_{E} and Y_{E} for final segment 64N) and compares to the coordinates of the cup 66 (X_{C},Y_{C}). If the length of the computed trajectory 64 is determined by the digital processing system 22 of the golf putting aid system 20 to significantly exceed the distance between a starting position 62 of the golf ball 53 and the cup 66 then the initial velocity estimate for segment 64A is reduced by the digital processing system 22 of the golf putting aid system 20. Alternately if the length of the computed trajectory 64 is determined by the digital processing system 22 of the golf putting aid system 20 to be significantly less than the distance between the starting position 62 of the golf ball 53 and the cup 66 then the initial velocity estimate for segment 64A is increased by the digital processing system 22 of the golf putting aid system 20. Additionally, if the ending location of the computed trajectory 64 is to the right of the cup 66 then the initial direction estimate for segment 64A is adjusted to the left by the digital processing system 22 of the golf putting aid system 20. Alternately if the ending location of the computed trajectory 64 is to the left of the cup 66 then the initial direction estimate for segment 64A is adjusted to the right by the digital processing system 22 of the golf putting aid system 20. Next the location of the new starting coordinates (X_{S},Y_{S}) of the golf ball 53 is reset by the digital processing system 22 of the golf putting aid system 20 to the starting point of the trajectory at segment 64A at ball starting position 62 and the golf ball 53 is re-launched along a velocity vector V having a new initial velocity and direction as determined in step 116 and this example may proceed back to step 106 as illustrated and described earlier to continue this example of the claimed technology.

In this example, the steps 106, 108, 112, 114, and 116 of FIG. 6 may be repeated by the digital processing system 22 of the golf putting aid system 20 with incrementally improved trajectories until one is found that causes the ball to reach the cup 66 at a low velocity such that the golf ball 53 drops into the cup 66. It should be noted that in this example the computational math supporting the segment and trajectory calculations can also include computations that support segment and trajectory calculations in which the ball is not only rolling on the surface, but can also be bouncing, skidding, skipping or otherwise airborne at least slightly so the ball is not rolling on the surface as well.

Once a computed trajectory 64 has been found that causes a golf ball 53 at a ball starting position 62 to reach the cup 66 by the digital processing system 22 of the golf putting aid system 20, information about the computed trajectory 64 may be conveyed to the golfer 50, and possibly to others that are not the golfer 50 for educational and entertainment purposes. The conveyance of the computed trajectory 64 information can be through any of a golfer's senses, including visually, audibly, or tactilely. For example, if the information about computed trajectory 64 is conveyed visually by the digital processing system 22 of the golf putting aid system 20, the computed trajectory 64 can be shown in a display device 32, such as with a head-mounted display or a hand-held display, such as a mobile phone, handset, or tablet, or a larger non-portable display set on a table-top. The display device 32 can also be another one coupled to the digital processing system 22 of the golf putting aid system 20 remote to the green 60 and/or in addition to one for the golfer 50, such as a remote television seen by a distant television audience. Alternately, if the information about computed trajectory 64 is conveyed audibly, the computed trajectory 64 can be conveyed through an earphone device 34 to the golfer 50, such as in a mobile phone, handset, or tablet, or even a remote television speaker coupled to the digital processing system 22 of the golf putting aid system 20. In another alternative, if the information about computed trajectory 64 is conveyed tactilely, the computed trajectory 64 can be conveyed through a golfer's putter 51 if so equipped with a vibrational tactile transducer 36 coupled to the digital processing system 22 of the golf putting aid system 20, for example, or through a mobile phone, handset, or tablet, which typically have built-in vibrational transducers.

An example of a method for using the golf putting aid system 20 will now be illustrated and described with reference to FIG. 7. In step 120, before the golfer 50 executes a putt, the golf putting aid system 20 may be activated and the 3D imager device 42 may be aimed, such that the field of view 70 encompasses or is intended to encompass the ball 53 laying on a green 60 at golf ball starting position 62, the cup 66, and at least that portion of the green 60 there between.

In step 122, the 3D imager device 42 of the golf putting aid system 20 is used to capture 3D image data of the green 60, the golf ball 60, and the cup 66, and this 3D image data is transmitted from the 3D imager device 42 to the digital processing system 22 of the golf putting aid system 20, although other types of image data may be captured. During this aiming process, the image data captured by the 3D imager device 42 may be presented on display device 32 by way of the digital processing system 22 of the golf putting aid system 20 to facilitate the aiming process until at least the portion of the green with the ball 53 and the cup 66 are within the field of view 70. As described earlier, the digital processing system 22 of the golf putting aid system 20 may execute image processing and object recognition on the captured data to determine when at least a portion of the green with the ball 53 and the cup 66 or other object or objects of interest are within the field of view 70.

In step 124, data about the green and/or an environment of the green 60 is sensed, captured, or otherwise input into the digital processing system 22 of the golf putting aid system 20, including by way of example only, data on a grain of the green 60 through keypad 48, speed or resistance data of the green 60 through a green speed meter device 46 coupled to or input keypad 48, inclination data of the 3D imager device 42 received from the inclinometer device 44, heading data from the compass device 40 indicating the direction that the 3D imager device 42 is pointing during the 3D imaging process, and wind speed and direction data from wind sensor device 38, although other types and/or numbers of environmental or other data related to the green 60 or putting or other process may be used. This data may be stored for example in memory 26 of digital processing system 22 for subsequent processing or may be used in real time.

In step 126, the digital processing system 22 of the golf putting aid system 20 computes a computed trajectory 64 that golf ball 53 can follow from starting position 62 to reach the cup 66 based upon the data collected in steps 122 and 124, such as by way of example the method illustrated and described with reference to FIGS. 3 and 6 illustrated and described herein. The computed trajectory 64 can then be shown on display device 32 by the digital processing system 22 of the golf putting aid system 20, overlaid atop the green 60 if desired. This computed trajectory 64 may be shown overlaid in the display device 32 superimposed onto a displayed image of the green 60 (said image can also include the ball 53 and the cup 66) and can move in accordance with the viewpoint of the golfer 50 as he or she moves, such movement being detected and measured by the compass device 40 (or alternately by apparent changes in the position of the ball 53 or the cup 66) which outputs heading information to the digital processing system 22 of the golf putting aid system 20 in real-time in this example so the digital processing system 22 of the golf putting aid system 20 can adjust the displayed image on display device 32 accordingly. Also, the desired aiming direction and speed (152 of FIG. 9) of the putt can be computed by digital processing system 22 and also shown overlaid in the display 32.

In step 128, as the golfer 50 approaches the golf ball 53 in preparation to make a putt, the digital processing system 22 of the golf putting aid system 20 may for example by virtue of 3D imager device 42 and/or one or more other sensors, such as inclinometer device 44 and compass device 40, process captured image data and/or other data, such as GPS data from a GPS device coupled to the digital processing system 22, and determine that the position of the golfer 50 is proximal to the golf ball 53. The digital processing system 22 of the golf putting aid system 20 may instruct the golfer 50—either through for example the display device 32, earphone device 34, and/or tactile transducer 36—to take a few practice swings of the putter 51. As the golfer 50 takes his or her practice swings, the 3D imager device 42 of golf putting aid system 20 may capture image data of the practice swings, transmit the 3D images or 3D video to the digital processing system 22 which in turn computes direction and velocity of the putter head 52 as well as the open or closed orientation of the putter head 52. The digital processing system 22 of the golf putting aid system 20 may also illustrate a comparison of the captured image data of the one or more practice swings to the desired initial direction and speed of the golf ball 53 determined earlier by the digital processing system 22 of the golf putting aid system 20 on display device 32, an example of which is shown in FIG. 9.

Referring to FIG. 9, the displayed image 140 presented to golfer 50 can include an image of the golf ball 53 and its computed desired launch vector 152 (which is essentially a representation of the initial velocity segment 64A) within a subset area 60B of green 60, an image of putter head 52 as well as putter swing indicator 154 which can be represented as a line or arrow parallel to the direction of the putt practice swing and whose length is proportional to the velocity of the putter head 52 during the practice swing. Also shown in displayed image 140 is anticipated launch vector 156 which is indicative of the how fast and in which direction a golf ball 53 will be hit if a practice swing was actually executed on the golf ball 53. The goal of the golfer 50 at this juncture is to have the direction and length of a desired launch vector 152 and anticipated launch vector 156 to be the same. If the desired launch vector 152 and anticipated launch vector 156 are substantially the same then the golf ball 53 will substantially follow computed trajectory 64 and reach the cup 66 when putted accordingly.

Referring back to FIG. 7, in step 130 the digital processing system 22 of golf putting aid system 20 determines if the desired launch vector 152 and the anticipated launch vector 156 are substantially identical, e.g. within a stored or otherwise set threshold difference. If the digital processing system 22 of golf putting aid system 20 determines the desired launch vector 152 and the anticipated launch vector 156 are not substantially identical, e.g. within a stored or otherwise set threshold difference, then a No branch can be taken to step 138.

In step 138, the digital processing system 22 of golf putting aid system 20 can provide visual feedback in the display device 32 in the form of textual data 142, indicating one or more corrective directions on how hard or where to hit the golf ball 53 (or equivalently, how to adjust the putter practice swings to accomplish that end), although other manners for providing corrective feedback may be used. In another example, the digital processing system 22 of golf putting aid system 20 can also provide corrective feedback information through earphone device 34 (e.g., the synthetic spoken words “hit harder” or “aim further left” can be heard in the earphone device 34), and/or tactilely in which the tactile transducer 36 may buzz, for example, when the desired launch vector 152 and the anticipated launch vector 156 are not substantially identical. After step 138, the digital processing system 22 of golf putting aid system 20 may proceed back to step 128 as illustrated and described earlier and this cycle may continue until the golfer 50 adjusts his practice swings so that the desired launch vector 152 and the anticipated launch vector 156 determined by the digital processing system 22 of golf putting aid system 20 are substantially the same, e.g. within a stored or otherwise set threshold.

If back in step 130 the digital processing system 22 of golf putting aid system 20 determines the desired launch vector 152 and the anticipated launch vector 156 are substantially identical, e.g. within a stored threshold difference, then the Yes branch can be taken to step 132. In step 132, after golfer 50 adjusts his practice swings such that the digital processing system 22 of golf putting aid system 20 determines the anticipated launch vector 156 substantially matches the desired launch vector 152, e.g. within a stored threshold difference, then the digital processing system 22 of golf putting aid system 20 can provide visual feedback, such as in the display in the form of textual data 142, indicating that the putt practice swings are optimal, although other types of feedback may be provided. By way of example, the digital processing system 22 of golf putting aid system 20 can also provide equivalent information through earphone device 34 (e.g., the synthetic spoken words “putt now” can be heard in the earphone device 34), or tactilely in which the tactile transducer 36 may stop buzzing, for example.

In step 134, the golfer 50 may execute the optimized putt swing as prescribed by the digital processing system 22 of golf putting aid system 20 for example the process illustrated and described in steps 128, 130, and 138. The digital processing system 22 of golf putting aid system may also capture 3D image data, by way of 3D imager 42, and digital processing system 22 of golf putting aid system 20 can determine the actual launch direction and initial speed of golf ball 53, and even the actual trajectory of golf ball 53, for later comparison to the prescribed launch vector and computed trajectory 64 for feedback to the golfer 50.

In step 136, this example of putting with the golf putting aid system 20 may end.

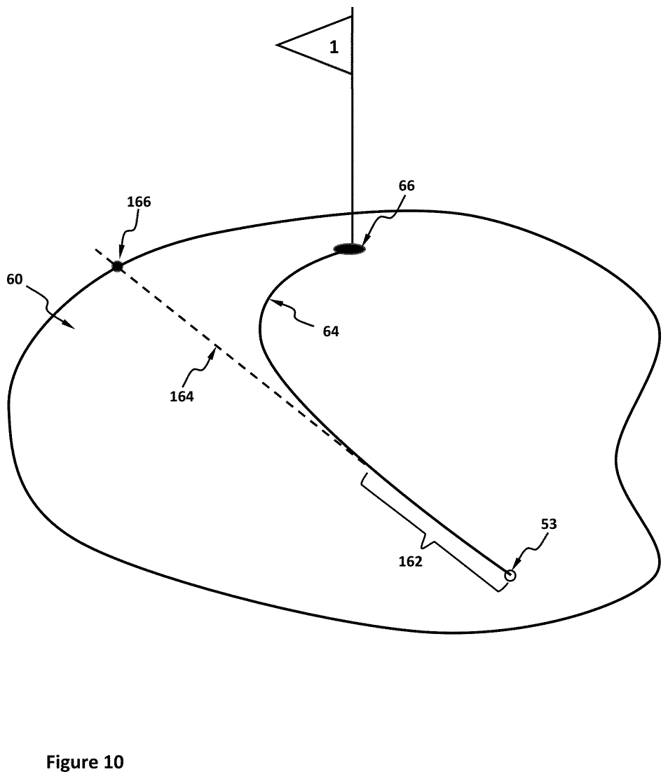

An alternate way of visually presenting information about where a golfer 50 should aim his or her putt is illustrated in FIG. 10. As seen in FIG. 10 the first portion of a trajectory 64 can be graphically and mathematically modelled as a straight line, shown as linear portion 162 in FIG. 10. The reason linear portion 162 is approximately linear is because the momentum due to the initial velocity of a putted golf ball is significantly greater than the other forces acting on the golf ball 53, such as those forces described in connection to FIGS. 8A and 8B, and consequently the initial path of trajectory 64 does not depart significantly from a straight line. An alternate reason linear portion 162 is approximately linear is because when a putt is initiated, the golf ball 53 may skid, skip, or even bounce during one or more of its initial segments along trajectory 64, in which case the golf ball 53 will not be substantially subjected to any side-to-side forces acting upon it by, for example, the grain of the green, or even the topography of the green, until the bouncing, skidding, skipping or otherwise at least slightly airborne segment(s) of the ball ends at the end of linear portion 162. The line of linear portion 162 can be extended, as shown by the dotted line extension 164 in FIG. 10, until the extension 164 reaches the edge of green 60, or even beyond the edge of green 60. But as shown in FIG. 10 an aiming point 166 is determined by digital processing system 22 to be the intersection of extension 164 and the edge of green 60, although other aiming points along extension 164 (both before the edge of the green 60 and beyond the edge of the green 60) can be determined as well. Note that the location of aiming point 166 can be determined in process step 126 of FIG. 7, and the position of aiming point 166 can be presented visually to a golfer 50 through display device 32 in the latter half of process step 126 of FIG. 7.

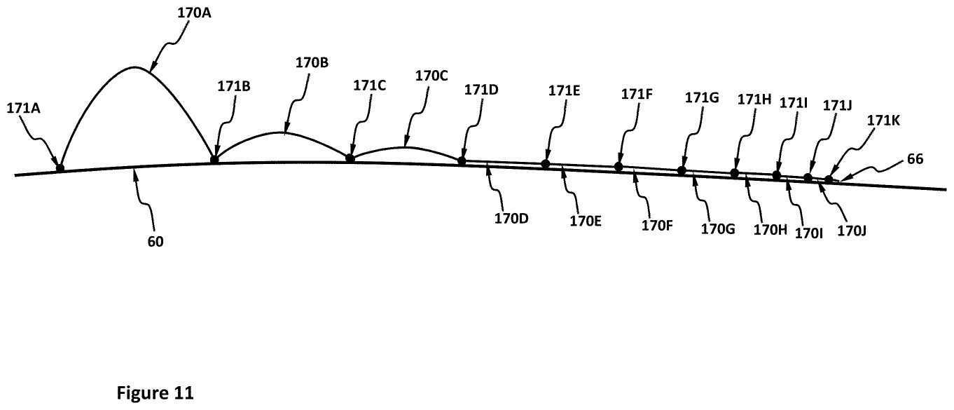

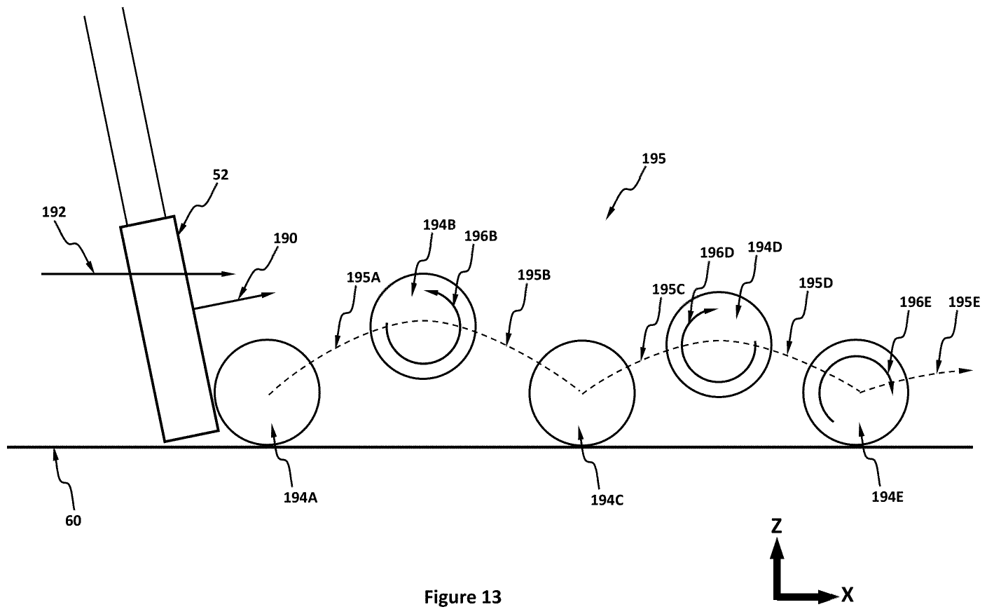

The determined trajectory up until now has been described, either implicitly or explicitly, as being on the surface of the green 60. However, examples of this technology can also determine trajectories in which a part of the trajectory, particularly the part comprising the first one or more initial segments, is not on the green 60. As an example, as shown in FIGS. 11 and 13, the golf ball may be launched into an upward direction when putted such that the golf ball momentarily loses contact with the green 60 before coming back down and contacting the green 60, whereupon it may bounce one or more times before remaining in contact with the green 60 for the remainder of the determined trajectory. As an example, as shown in FIG. 11, a golf ball residing at location 171A may be launched into a parabolic (or ballistic) arc along segment path 170A, which can happen, for example, if the putting face is “open” as described below in connection with FIG. 13. After the ball traverses segment 170A it will regain contact with the green 60 at location 171B, whereupon the ball may bounce again from location 171B into segment path 170B and become airborne. Alternately, as shown in a later path segment 170D, the ball may remain in contact with the green 60 and commence to roll on the green in segment 170D, after completing a previous airborne segment such as segment 170C. Importantly, the trajectory determination process of examples of this technology can take into account one or more airborne segments, such as segments 170A and 170C (including segment characteristics such as peak height and longitudinal distance between contact points such as location 171B and 171C), as well as numbers of one or more bounces, all of which—if not included—can cause significant errors in the resulting determined trajectory.

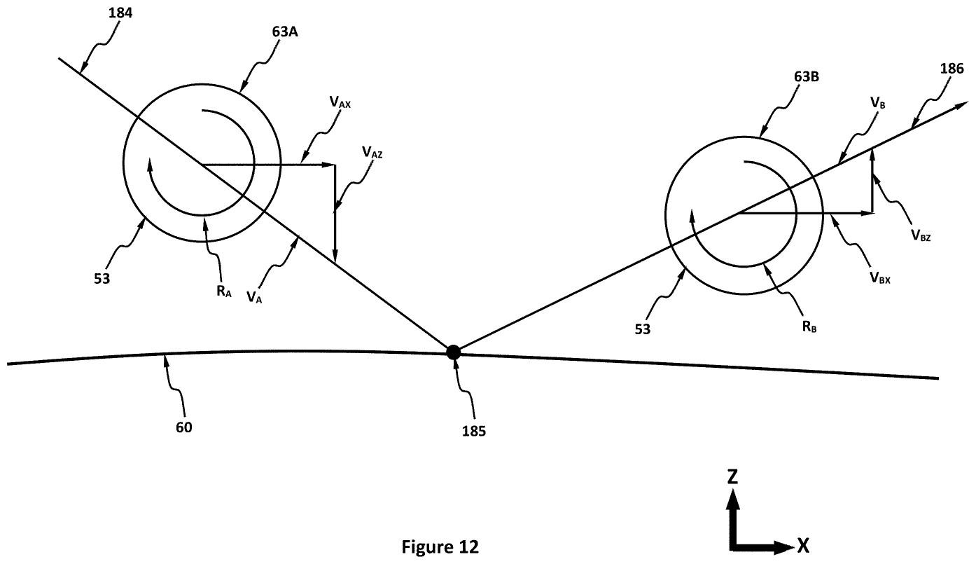

The computational math describing the mechanics of a golf ball undergoing a bounce of a trajectory can be described with reference to FIG. 12. As seen in FIG. 12, which is a side-view illustration of the change of angular momentum and translational momentum a golf ball undergoes when it bounces or skips on a green, a golf ball at an initial airborne position 63A just before another bounce at segment end-point 185 is rotating about R_{A} with a rotational velocity ω_{A} and translating with a velocity V_{A} whose magnitude is sqrt(V_{AX}²+V_{AZ}²), and has an elevation a small differential distance dZ_{A} above the green 60. The elevation dZ_{A} is assumed to be differentially small so potential energy effects on the golf ball before the bounce can be assumed to be negligible. After the bounce or skip on the green resulting in airborne position 63A, a golf ball at a next post-bounce airborne position 63B just after the bounce off the green 60 at segment end-point 185 is rotating about RB with a rotational velocity ω_{B} and translating with a velocity V_{B} whose magnitude is sqrt(V_{BX}²+V_{BZ}²), and has an elevation a small differential distance dZ_{B} above the green 60. The elevation dZ_{B} is assumed to be differentially small so potential energy effects on the golf ball after the bounce can be assumed to be negligible. Before the bounce the golf ball's energy is E_{A}=1/2mV_{A}²+/1/2Iω_{A}², where m is the mass of the golf ball and I is the moment of inertia of the golf ball. Note that m and I are constants and well-known, the values of V_{A} and ω_{A} can be computed from previous segments or from captured knowledge of the putting stroke that launched the ball 53 into its initial segment, and therefore the value of E_{A} can be readily computed from knowledge of these parameters. After the bounce at segment end-point 185 the golf ball's energy is E_{B}=1/2mV_{B}²+1/2Iω_{B}²=E_{A}−E_{friction} where E_{friction} is the energy the golf ball loses due to friction at the bounce or skip on the green 60 at segment end-point 185. The value of E_{friction} can be computed from data input to the digital processing system 22 from the green speed meter 46 as well as knowledge of the known values of V_{A} and ω_{A}. Accordingly, the post-bounce values of V_{B} and D_{B} can also be computed or otherwise determined as well. In aggregate, the determination of the rotational velocities and translational velocities of the airborne segments can be used to determine the trajectory of a golf ball even if many of the segments do not lie on the surface of the green 60.

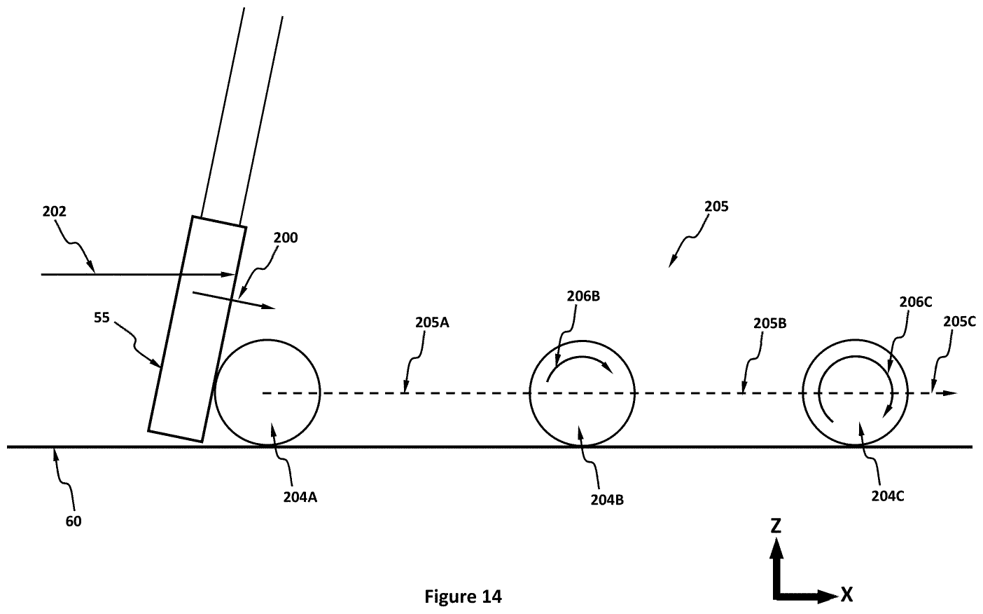

Whether the ball follows a bouncing path, such as ball path 195 as illustrated in FIG. 13, or a skipping path such as ball path 205 as illustrated in FIG. 14, is a strong function of whether the putting head 52 is positioned in an “open face” orientation as shown in FIG. 13 or in a “closed face” orientation as shown in FIG. 14. In an open face orientation the putting head normal direction 190 is pointing slightly upward away from the green 60 as shown in FIG. 13 while in a closed face orientation the putting head normal direction 200 is pointing slightly downward towards the green 60 as shown in FIG. 14. As shown in FIG. 13, when the stationary golf ball 60 at green location 194A is struck by an open faced putter moving along velocity vector 192 with putting head normal direction 190, the golf ball will become airborne with a substantial vertical elevation above the green, and moves translationally at a significant forward velocity along segment pat 195A wherein the launch angle of the golf ball from 194A is a function of the putter's velocity vector 192 and head normal vector 190. Further, when the stationary golf ball 60 at green location 194A is struck by an open faced putter moving along velocity vector 192 with putting head normal direction 190, the golf ball will become airborne along segment 195A with a substantial rotational velocity 196B that is also a function of velocity vector 192 and putting head normal velocity vector 190. Note that segment 195A can have a substantially parabolic or ballistic profile. Importantly, by virtue of the 3D imager 42, the putting head 52 and the practice swings of the putter can be imaged, as described in connection with FIG. 9, and both the anticipated head normal vector 190 and velocity vector 192 can be determined by the digital processing system 22 from the captured 3D imagery of the practice putt swing, from which the vertical components (i.e., in the Z-direction) of the segments comprising a trajectory can be determined, from which the full trajectory can be computed as well.

As shown in FIG. 14, when the stationary golf ball 60 at green location 204A is struck by a closed faced putter moving along velocity vector 202 with putting head normal direction 200, will not have a substantial vertical elevation above the green 60, and moves translationally at a significant forward velocity along 205A along a substantially linear skidding segment wherein the velocity of the golf ball along 205A is a function of the putter's velocity vector 202 and head normal vector 200. Further, when the stationary golf ball 60 at green location 204A is struck by a closed faced putter moving along velocity vector 202 with putting head normal direction 200, the golf ball will skip or skid along the surface of the green 60 substantially along segment 205A with a rotational velocity 206B that increases from zero at 204A until friction with the green 60 as the ball traverses 205A and 205B causes the rotational velocity of the ball 53 to reach a terminal value which is proportional to the forward translational velocity of the ball. That is, the skidding or skipping motion of the ball along path 205A and 205B becomes a rolling motion when the ball is again in full contact with the green, at which time the forward translational velocity of the ball is equal to Ro, where R is the radius of the ball. Importantly, by virtue of the 3D imager 42, the practice swings of the putter can be imaged, as described in connection with FIG. 9, and both the anticipated head normal vector 200 and velocity vector 202 can be determined by the digital processing system 22 from the captured 3D imagery of the practice putt swing, from which the open versus closed face orientation of the putting head can be determined, from which the vertical components, if any, of the segments comprising a trajectory can be determined, from which the full trajectory can be computed as well.

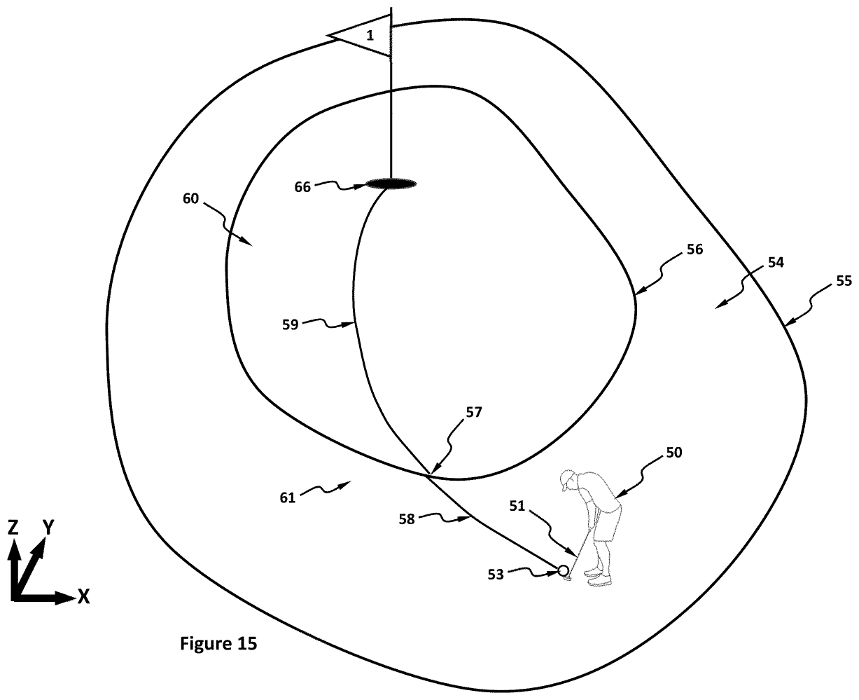

Heretofore the golf putting aid 20 has been described as being useful when the initial position of a golf ball is on the green, and the surface over which the ball traverses a trajectory is substantially continuous and uniform (although not necessarily flat). However, the golf putting aid 20 can also beneficially determine a trajectory from a ball's initial location on a fringe area surrounding the green, such that when putted from the fringe the ball can follow the prescribed trajectory and reach the cup. Such a scenario is illustrated in FIG. 15 wherein a golf ball 53 is shown lying on the fringe area 54 surrounding the green 60, and a discontinuity 57 separates the green 60 and the fringe area 54. When computing a trajectory 61 when a discontinuity 57 is present, the trajectory can be subdivided into two parts, a fringe trajectory 58 and a green trajectory 59, such that when the green trajectory 59 is concatenated onto the end of the fringe trajectory 58, a full trajectory 61 is formed that can cause the putted ball 53 to reach the cup 66. Note that the values of the mathematical and physical parameters, such as the values of resistance (as can be measured by way of example by a green speed meter or Stimpmeter 46) and grain, describing the surface of the fringe 54 for fringe trajectory 58 computation can be substantially different than the values of the mathematical and physical parameters describing the surface of the green 60 needed for computation of green trajectory 59.

Furthermore, the discontinuity 57 can not only represent that boundary at which the values of the mathematical and physical parameters change, the discontinuity 57 can also be that boundary where there is a change in elevation between the surfaces separated by the discontinuity 57, and this change in elevation can be taken into account by the trajectory determining process. For example, if the fringe 54 is at a slightly higher elevation than the green 60, then the ball 53 can become airborne as it traverses the discontinuity 57, in which case the algorithms and equations described in connection with FIG. 12 must be utilized so the trajectory of the golf ball can be accurately determined as it enters the green 60. Nonetheless it should be noted that the ball 53 can become airborne for other reasons as it traverses the discontinuity 57, such as might happen if the ball 53 is bouncing, skidding, skipping, etc., as it approaches the discontinuity 57, or if ball 53 passes over fringe area 54 and discontinuity 57 after it is struck by the putter 51 into a fringe trajectory 58 whose initial segment(s) are all in the air.

Although in the example herein the terms “green” or “golf green” are used and generally apply to a golf putting aid 20, the terms “green” or “golf green” can be replaced and examples of this technology may be used on any playing surface or surfaces of interest over which a trajectory is to be computed in accordance with this example. It should be further noted that while the terms “ball” or “golf ball” are used and generally apply to a golf putting aid 20, the terms “ball” or “golf ball” can be replaced and examples of this technology may be used to work with any substantially spherical object whose trajectory is to be computed in accordance with this example as it rolls across a surface of interest. Finally, it should be further noted that while the term “cup” is used and generally applies to a golf putting aid 20, the term “cup” can be replaced and examples of this technology may be used to include any destination of a spherical object whose trajectory is to be computed in accordance with this example as it rolls across or otherwise travels along or above a surface of interest.

Having thus described the basic concept of the invention, it will be rather apparent to those skilled in the art that the foregoing detailed disclosure is intended to be presented by way of example only and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations, such as arrows in the diagrams therefore, is not intended to limit the claimed processes to any order or direction of travel of signals or other data and/or information except as may be specified in the claims. Accordingly, the invention is limited only by the following claims and equivalents thereto.

What is claimed is:

1. An electronic golfing aid system, comprising:
at least one processor;
a memory coupled to the processor which is configured to be capable of executing programmed instructions comprising and stored in the memory to:
obtain image data comprising at least one of a playing surface, a ball, or a designated location spaced from the ball on the playing surface;
determine at least one type of spatial data and at least one type of playing surface data relating to the playing surface, the ball and the designated location;
compute an overall trajectory, a starting direction, and an initial velocity of the ball to reach the designated location, wherein the compute the overall trajectory identifies and accounts for at least one airborne segment; and
provide the computed overall trajectory, the starting direction, and the initial velocity of the ball.

2. The system as set forth in claim 1 wherein for the compute the overall trajectory, the processor is further configured to be capable of executing the stored programmed instructions to:
determine one of a plurality of types of airborne segments anticipated for the ball; and
adjusting an angular velocity and a translational velocity in the computation of the overall trajectory based on the determined one of the plurality of types of airborne segments anticipated for the ball.

3. The system as set forth in claim 2 wherein the types of airborne segments from which the determine one of a plurality of types of airborne segments identifies comprises: at least one parabolic airborne segment anticipated for the ball; a substantially linear skidding segment anticipated for the ball; and a discontinuity in the surface between the ball and the designated location.

4. The system as set forth in claim 3 wherein the determine the one of the plurality of types of airborne segments anticipated for the ball is based on obtaining at least one of practice image data of at least one practice swing with a sporting device to simulate a practice speed and practice direction or surface image data comprising at least one of the playing surface, wherein the playing surface comprises surface sections which extend along different planes at the discontinuity.

5. The system as set forth in claim 1 wherein for the obtain image data, the processor is further configured to be capable of executing the stored programmed instructions to:
capture, with the image capture device, three-dimensional image data comprising at least one of the playing surface, the ball, or the designated location spaced from the ball on the playing surface.

6. The system as set forth in claim 5 wherein for the capture image data, the processor is further configured to be capable of executing the stored programmed instructions to:
execute object recognition on the image data to determine when the ball and the designated location are in the image data; and
continue to capture additional image data until the executed object recognition on the additional image data determines the ball and the designated location are in the additional image data.

7. The system as set forth in claim 5 wherein for the determine the at least one type of spatial data, the processor is further configured to be capable of executing the stored programmed instructions to:
determine based on the three-dimensional image data at least a distance and any elevation difference between the ball and the designated location on the playing surface;
wherein the compute the overall trajectory, the starting direction, and the initial velocity of the ball to reach the designated location is further based on the determined distance and any elevation difference.

8. The system as set forth in claim 1 wherein the processor is further configured to be capable of executing the stored programmed instructions to:
obtain, with a wind sensor coupled to the at least one processor, wind data on the playing surface;
wherein the compute the overall trajectory, the starting direction, and the initial velocity of the ball to reach the designated location is further based on the obtained wind data.

9. The system as set forth in claim 1 wherein for the determine at least one type of playing surface data, the processor is further configured to be capable of executing the stored programmed instructions to:
obtain green speed data related to the playing surface;
wherein the compute the overall trajectory, the starting direction, and the initial velocity of the ball to reach the designated location is further based on the obtained green speed data.

10. The system as set forth in claim 1 wherein for the determine at least one type of playing surface data, the processor is further configured to be capable of executing the stored programmed instructions to:
receive, with the interface system, an input of green grain data between the ball and the designated location on the playing surface;
wherein the compute the overall trajectory, the starting direction, and the initial velocity of the ball to reach the designated location is further based on the obtained green grain data.

11. The system as set forth in claim 1 wherein the processor is further configured to be capable of executing the stored programmed instructions to:
capture, with the image capture device, practice image data of at least one practice swing with a sporting device to simulate a practice speed and practice direction;
compute the practice trajectory, the practice direction, and the practice velocity of the ball to reach the designated location;
compare the practice trajectory, the practice direction, and the practice velocity of the ball against the computed overall trajectory, the starting direction, and the initial velocity of the ball; and
provide, with the interface system, feedback data based on the comparison.

12. The system as set forth in claim 1 wherein for the provide the feedback data, the processor is further configured to be capable of executing the stored programmed instructions to:
display, with a display device coupled to the at least one processor, the practice trajectory and the computed overall trajectory.

13. The system as set forth in claim 1 wherein for the provide the feedback data, the processor is further configured to be capable of executing the stored programmed instructions to:
provide, with a tactile transducer device coupled to the at least one processor, tactile feedback relating to the at least one of the practice direction or the practice velocity of the ball with respect to a corresponding one of the starting direction or the initial velocity of the ball.

14. The system as set forth in claim 1 wherein for the provide the feedback data, the processor is further configured to be capable of executing the stored programmed instructions to:
provide, with at least one speaker device coupled to the at least one processor, audio feedback relating to the at least one of the practice direction or the practice velocity of the ball with respect to a corresponding one of the starting direction or the initial velocity of the ball.

15. A non-transitory computer readable medium having stored thereon instructions comprising executable code which when executed by at least one processor, cause the processor to:
obtain image data comprising at least one of a playing surface, a ball, or a designated location spaced from the ball on the playing surface;
determine at least one type of spatial data, at least one type of weather element data, and at least one type of playing surface data relating to the playing surface, the ball and the designated location;
compute an overall trajectory, a starting direction, and an initial velocity of the ball to reach the designated location, wherein the compute the overall trajectory identifies and accounts for at least one airborne segment; and
provide the computed overall trajectory, the starting direction, and the initial velocity of the ball.

16. The medium as set forth in claim 15 wherein for the compute the overall trajectory, the executable code, when executed by the processor, further causes the processor to:
determine one of a plurality of types of airborne segments anticipated for the ball; and
adjusting an angular velocity and a translational velocity in the computation of the overall trajectory based on the determined one of the plurality of types of airborne segments anticipated for the ball.

17. The medium as set forth in claim 16 wherein the types of airborne segments from which the determine one of a plurality of types of airborne segments identifies comprises: at least one parabolic airborne segment anticipated for the ball; a substantially linear skidding segment anticipated for the ball; and a discontinuity in the surface between the ball and the designated location.

18. The medium as set forth in claim 17 wherein the determine the one of the plurality of types of airborne segments anticipated for the ball is based on obtaining at least one of practice image data of at least one practice swing with a sporting device to simulate a practice speed and practice direction or surface image data comprising at least one of the playing surface, wherein the playing surface comprises surface sections which extend along different planes at the discontinuity.

19. The medium as set forth in claim 15 wherein for the obtain the image data, the executable code, when executed by the processor, further causes the processor to:
capture three-dimensional image data comprising at least one of the playing surface, the ball, or the designated location spaced from the ball on the playing surface.

20. The medium as set forth in claim 19 wherein for the capture image data, the executable code, when executed by the processor, further causes the processor to:
execute object recognition on the image data to determine when the ball and the designated location are in the image data; and
continue to capture additional image data until the executed object recognition on the additional image data determines the ball and the designated location are in the additional image data.

21. The medium as set forth in claim 15 wherein for the determine the at least one type of spatial data, the executable code, when executed by the processor, further causes the processor to:
determine based on the three-dimensional image data at least a distance and any elevation difference between the ball and the designated location on the playing surface;
wherein the compute the overall trajectory, the starting direction, and the initial velocity of the ball to reach the designated location is further based on the determined distance and any elevation difference.

22. The medium as set forth in claim 15 wherein the processor is further configured to be capable of executing the stored programmed instructions to:
obtain wind data on the playing surface;
wherein the compute the overall trajectory, the starting direction, and the initial velocity of the ball to reach the designated location is further based on the obtained wind data.

23. The medium as set forth in claim 15 wherein for the determine at least one type of playing surface data, the executable code, when executed by the processor, further causes the processor to:
obtain green speed data related to the playing surface;
wherein the compute the overall trajectory, the starting direction, and the initial velocity of the ball to reach the designated location is further based on the obtained green speed data.

24. The medium as set forth in claim 15 wherein for the determine at least one type of playing surface data, the executable code, when executed by the processor, further causes the processor to:
receive an input of green grain data between the ball and the designated location on the playing surface;
wherein the compute the overall trajectory, the starting direction, and the initial velocity of the ball to reach the designated location is further based on the obtained green grain data.

25. The medium as set forth in claim 15 wherein the executable code, when executed by the processor, further causes the processor to:
obtain practice image data of at least one practice swing with a sporting device to simulate a practice speed and practice direction;
compute the practice trajectory, the practice direction, and the practice velocity of the ball to reach the designated location;
compare the practice trajectory, the practice direction, and the practice velocity of the ball against the computed overall trajectory, the starting direction, and the initial velocity of the ball; and
provide feedback data based on the comparison.

26. The medium as set forth in claim 15 wherein for the provide the feedback data, the processor is further configured to be capable of executing the stored programmed instructions to:
display the practice trajectory and the computed overall trajectory.

27. The medium as set forth in claim 15 wherein for the provide the feedback data, the executable code, when executed by the processor, further causes the processor to:
engage a tactile transducer device to provide tactile feedback relating to the at least one of the practice direction or the practice velocity of the ball with respect to a corresponding one of the starting direction or the initial velocity of the ball.

28. The medium as set forth in claim 15 wherein for the provide the feedback data, the executable code, when executed by the processor, further causes the processor to:
engage with at least one speaker device to provide audio feedback relating to the at least one of the practice direction or the practice velocity of the ball with respect to a corresponding one of the starting direction or the initial velocity of the ball.

29. A method comprising:
obtaining by a computing device, image data comprising at least one of a playing surface, a ball, or a designated location spaced from the ball on the playing surface;
determining, by the computing device, at least one type of spatial data, at least one type of weather element data, and at least one type of playing surface data relating to the playing surface, the ball and the designated location;
computing, by the computing device, an overall trajectory, a starting direction, and an initial velocity of the ball to reach the designated location, wherein the computing the overall trajectory identifies and accounts for at least one airborne segment; and
providing, by the computing device, the computed overall trajectory, the starting direction, and the initial velocity of the ball.

30. The method as set forth in claim 29 further comprising:
determining, by the computing device, one of a plurality of types of airborne segments anticipated for the ball; and
adjusting, by the computing device, an angular velocity and a translational velocity in the computation of the overall trajectory based on the determined one of the plurality of types of airborne segments anticipated for the ball.

31. The method as set forth in claim 30 wherein the types of airborne segments from which the determining one of a plurality of types of airborne segments identifies comprises: at least one parabolic airborne segment anticipated for the ball; a substantially linear skidding segment anticipated for the ball; and a discontinuity in the surface between the ball and the designated location.

32. The method as set forth in claim 31 wherein the determining the one of the plurality of types of airborne segments anticipated for the ball is based on obtaining, by the computing device, at least one of practice image data of at least one practice swing with a sporting device to simulate a practice speed and practice direction or surface image data comprising at least one of the playing surface, wherein the playing surface comprises surface sections which extend along different planes at the discontinuity.

33. The method as set forth in claim 32 wherein the obtaining image data further comprises:
capturing, by an image capture device coupled to a computing device, three-dimensional image data comprising at least one of the playing surface, the ball, or the designated location spaced from the ball on the playing surface.

34. The method as set forth in claim 33 wherein the capturing image data, further comprises:
executing, by the computing device, object recognition on the image data to determine when the ball and the designated location are in the image data; and
continuing to capture, by the computing device, additional image data until the executed object recognition on the additional image data determines the ball and the designated location are in the additional image data.

35. The method as set forth in claim 33 wherein the determining the at least one type of spatial data, further comprises:
determining, by the computing device, based on the three-dimensional image data at least a distance and any elevation difference between the ball and the designated location on the playing surface;
wherein the computing the overall trajectory, the starting direction, and the initial velocity of the ball to reach the designated location is further based on the determined distance and any elevation difference.

36. The method as set forth in claim 29 wherein the determining at least one type of the weather element data further comprises:
obtaining, by a wind sensor coupled to the computing device, wind data on the playing surface;
wherein the compute the overall trajectory, the starting direction, and the initial velocity of the ball to reach the designated location is further based on the obtained wind data.

37. The method as set forth in claim 29 wherein the determining at least one type of playing surface data further comprises:
obtaining, by the computing device, green speed data related to the playing surface;
wherein the compute the overall trajectory, the starting direction, and the initial velocity of the ball to reach the designated location is further based on the obtained green speed data.

38. The method as set forth in claim 29 wherein the determining at least one type of playing surface data further comprises:
receiving, by the interface system coupled to the computing device, an input of green grain data between the ball and the designated location on the playing surface;
wherein the computing the overall trajectory, the starting direction, and the initial velocity of the ball to reach the designated location is further based on the obtained green grain data.

39. The method as set forth in claim 29 further comprising:
capturing, by the image capture device coupled to the computing device, practice image data of at least one practice swing with a sporting device to simulate a practice speed and practice direction;
computing, by the computing device, the practice trajectory, the practice direction, and the practice velocity of the ball to reach the designated location;
comparing, by the computing device, the practice trajectory, the practice direction, and the practice velocity of the ball against the computed overall trajectory, the starting direction, and the initial velocity of the ball; and
provide, by the interface system coupled to the computing device, feedback data based on the comparison.

40. The method as set forth in claim 29 wherein the providing the feedback data further comprises:
displaying, with a display device coupled to the computing device, the practice trajectory and the computed overall trajectory.

41. The method as set forth in claim 29 wherein the providing the feedback data, further comprises:
providing, with a tactile transducer device coupled to the computing device, tactile feedback relating to the at least one of the practice direction or the practice velocity of the ball with respect to a corresponding one of the starting direction or the initial velocity of the ball.

42. The method as set forth in claim 29 further comprising:
providing, by at least one speaker device coupled to the computing device, audio feedback relating to the at least one of the practice direction or the practice velocity of the ball with respect to a corresponding one of the starting direction or the initial velocity of the ball.
